(19) United States
(12) Patent Application Publication
(10) Pub. No.: US 2009/0217464 A1
(43) Pub. Date: Sep. 3, 2009

(54) DETERGENT COMPOSITION COMPRISING LIPASE

(76) Inventors: Philip Frank Souter, Northumberland (GB); Neil Joseph Lant, Newcastle (GB); Therese Clare Haynes, Gateshead (GB); Jesper Vind, Vaerloese (DK); Kim Borch, Birkeroed (DK); Allan Svendsen, Hoersholm (DK); Robert Van der Lans, Valby (DK); Lise Munch Mikkelsen, Roedovre (DK); Christian Isak Jorgensen, Bagsvaerd (DK); Shamkant Anant Patkar, Lyngby (DK)

Correspondence Address: THE PROCTER & GAMBLE COMPANY;Global Legal Department - IP, Sycamore Building - 4th Floor, 299 East Sixth Street, CINCINNATI, OH, 45202, US

(21) Appl. No.: 12/393,136

(22) Filed: Feb. 26, 2009

Related U.S. Application Data
(60) Provisional application No. 61/067,720, filed on Feb. 29, 2008.

(51) Int. Cl. C11D 3/386; C12S 11/00; C11D 3/50

(52) U.S. Cl. 8/137; 510/320; 510/323; 510/107

(57) ABSTRACT

The invention provides detergent compositions comprising lipolytic enzyme variants having improved in-detergent stability. Lipolytic enzyme variants with improved in-detergent stability are obtained by substituting certain specified amino acid residues in a parent lipolytic enzyme.

### CROSS REFERENCE TO RELATED APPLICATION(S)

This application claims the benefit of U.S. Provisional Application 61/067,720 filed 29 Feb. 2008.

### FIELD OF THE INVENTION

The present invention relates to lipolytic enzyme variants with improved in-detergent stability and to a method of preparing them. It particularly relates to lipolytic enzyme variants of the Thermomyces lanuginosus lipase.

### BACKGROUND OF THE INVENTION

It is known to use fungal lipolytic enzymes, e.g. the lipase from Thermomyces lanuginosus (synonym Humicola lanuginosa), for various industrial purposes, e.g. to improve the efficiency of detergents. Thus, a lipase derived from Thermomyces lanuginosus (synonym Humicola lanuginosa, EP 258 068 and EP 305 216) is sold for detergent use under the trade name Lipolase® (product of Novozymes A/S). WO 0060063 describes variants of the T. lanuginosus lipase with a particularly good first-wash performance in a detergent solution. In addition to the use of lipases as detergent enzymes to remove lipid or fatty stains from clothes and other textiles, they are also used as additives to dough for bread and other baked products, and in the elimination of pitch problems in pulp and paper production. In some applications, a lipolytic enzyme with improved thermostability is desirable (EP 374700, WO 9213130), whereas in other applications an in-detergent stability is desirable. WO 92/05249, WO 92/19726 and WO 97/07202 disclose variants of the T. lanuginosus (H. lanuginosa) lipase.

### SUMMARY OF THE INVENTION

In a first aspect, the invention relates to a detergent composition comprising a variant of a parent lipolytic enzyme, wherein the variant: (a) has an amino acid sequence which compared to the parent lipolytic enzyme comprises substitution of an amino acid residue corresponding to any of amino acids 27, 216, 227, 231, 233 and 256 of SEQ ID NO: 2; and (b) optionally is more in-detergent stable than the parent lipolytic enzyme.

In further aspects, the invention relates to use of the composition in the hydrolysis of a carboxylic acid ester or in the hydrolysis, synthesis or interesterification of an ester.

In a further aspect, the invention relates to use of the lipolytic enzyme variant for the manufacture of an in-detergent stable formulation.

### BRIEF DESCRIPTION OF THE FIGURES

FIG. 1 shows the alignment of lipases.

### SEQUENCE LISTINGS

SEQ ID NO: 1 shows the DNA sequence encoding lipase from Thermomyces lanoginosus.

SEQ ID NO: 2 shows the amino acid sequence of a lipase from Thermomyces lanoginosus.

SEQ ID NO: 3 shows the amino acid sequence of a lipase from Absidia reflexa.

SEQ ID NO: 4 shows the amino acid sequence of a lipase from Absidia corymbifera.

SEQ ID NO: 5 shows the amino acid sequence of a lipase from Rhizomucor miehei.

SEQ ID NO: 6 shows the amino acid sequence of a lipase from Rhizopus oryzae.

SEQ ID NO: 7 shows the amino acid sequence of a lipase from Aspergillus niger.

SEQ ID NO: 8 shows the amino acid sequence of a lipase from Aspergillus tubingensis.

SEQ ID NO: 9 shows the amino acid sequence of a lipase from Fusarium oxysporrum.

SEQ ID NO: 10 shows the amino acid sequence of a lipase from Fusarium heterosporum.

SEQ ID NO: 11 shows the amino acid sequence of a lipase from Aspergillus oryzae.

SEQ ID NO: 12 shows the amino acid sequence of a lipase from Penicillium camemberti.

SEQ ID NO: 13 shows the amino acid sequence of a lipase from Aspergillus foetidus.

SEQ ID NO: 14 shows the amino acid sequence of a lipase from Aspergillus niger.

SEQ ID NO: 15 shows the amino acid sequence of a lipase from Aspergillus oryzae.

SEQ ID NO: 16 shows the amino acid sequence of a lipase from Landerina penisapora.

### DETAILED DESCRIPTION OF THE INVENTION

Nomenclature for Amino Acid Modifications

In describing lipase variants according to the invention, the following nomenclature is used for ease of reference:

Original Amino Acid(s):Position(s):Substituted Amino Acid(s)

According to this nomenclature, for instance the substitution of glutamic acid for glycine in position 195 is shown as G195E. A deletion of glycine in the same position is shown as G195*, and insertion of an additional amino acid residue such as lysine is shown as G195GK. Where a specific lipase contains a “deletion” in comparison with other lipases and an insertion is made in such a position this is indicated as *36D for insertion of an aspartic acid in position 36.

Multiple mutations are separated by pluses, i.e.: R170Y+G195E, representing mutations in positions 170 and 195 substituting tyrosine and glutamic acid for arginine and glycine, respectively.

X231 indicates the amino acid in a parent lipolytic enzyme corresponding to position 231, when applying the described alignment procedure. X231R indicates that the amino acid is replaced with R. For SEQ ID NO: 2 X is T, and X231R thus indicates a substitution of T in position 231 with R. Where the amino acid in a position (e.g. 231) may be substituted by another amino acid selected from a group of amino acids, e.g. the group consisting of R and P and Y, this will be indicated by X231R/P/Y.

In all cases, the accepted IUPAC single letter or triple letter amino acid abbreviation is employed.

Identity: The term “identity” as used herein means the relatedness between two amino acid sequences or between two nucleotide sequences is described by the parameter “identity”.

For purposes of the present invention, the alignment of two amino acid sequences is determined by using the Needle program from the EMBOSS package (http://emboss.org) version 2.8.0. The Needle program implements the global alignment algorithm described in Needleman, S. B. and Wunsch, C. D. (1970) J. Mol. Biol. 48, 443-453. The substitution matrix used is BLOSUM62, gap opening penalty is 10, and gap extension penalty is 0.5.

The degree of identity between an amino acid sequence of the present invention (“invention sequence”; e.g. amino acids 1 to 269 of SEQ ID NO: 2) and a different amino acid sequence (“foreign sequence”) is calculated as the number of exact matches in an alignment of the two sequences, divided by the length of the “invention sequence” or the length of the “foreign sequence”, whichever is the shortest. The result is expressed in percent identity.

An exact match occurs when the “invention sequence” and the “foreign sequence” have identical amino acid residues in the same positions of the overlap. The length of a sequence is the number of amino acid residues in the sequence (e.g. the length of SEQ ID NO: 2 are 269).

The above procedure may be used for calculation of identity as well as homology and for alignment. In the context of the present invention homology and alignment has been calculated as described below.

Homology and Alignment

For purposes of the present invention, the degree of homology may be suitably determined by means of computer programs known in the art, such as GAP provided in the GCG program package (Program Manual for the Wisconsin Package, Version 8, August 1994, Genetics Computer Group, 575 Science Drive, Madison, Wis., USA 53711) (Needleman, S. B. and Wunsch, C. D., (1970), Journal of Molecular Biology, 48, 443-45), using GAP with the following settings for polypeptide sequence comparison: GAP creation penalty of 3.0 and GAP extension penalty of 0.1.

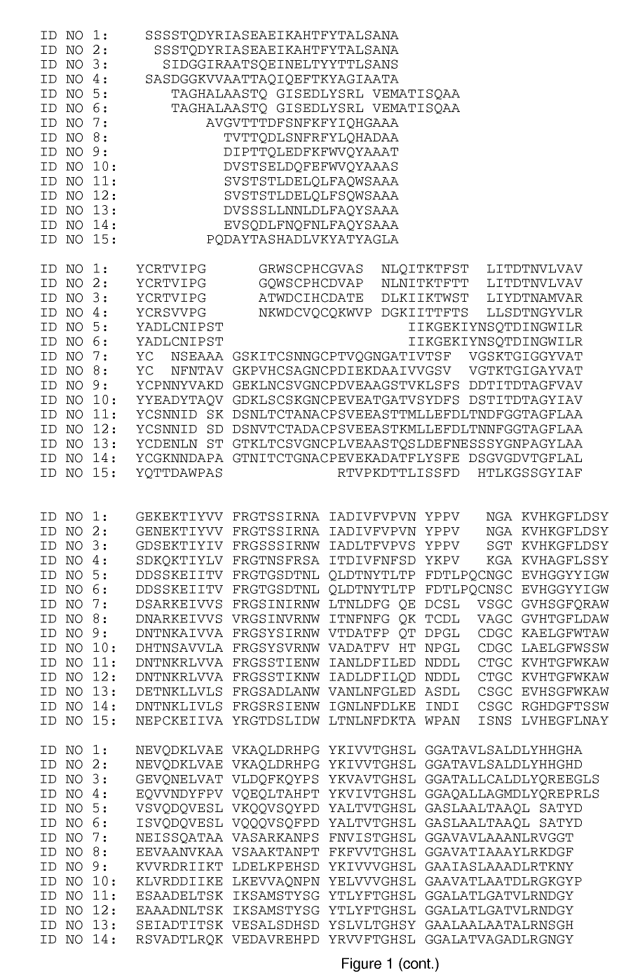

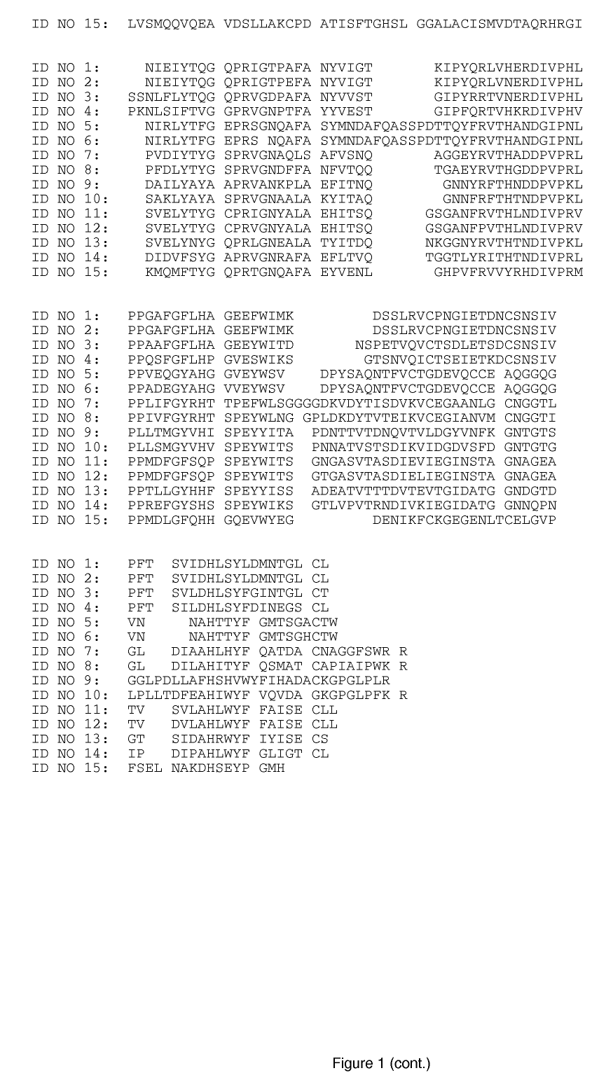

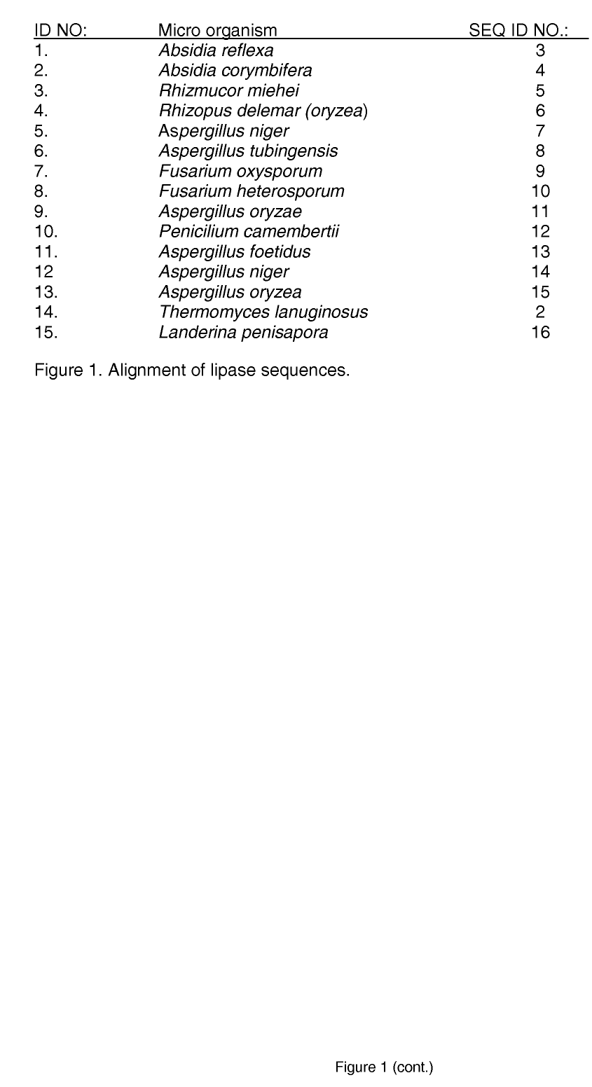

In the present invention, corresponding (or homologous) positions in the lipase sequences of Absidia reflexa, Absidia corymbefera, Rhizmucor miehei, Rhizopus delemar, Aspergillus niger, Aspergillus tubigensis, Fusarium oxysporum, Fusarium heterosporum, Aspergillus oryzea, Penicilium camembertii, Aspergillus foetidus, Aspergillus niger, Thermomyces lanoginosus (synonym: Humicola lanuginose) and Landerina penisapora are defined by the alignment shown in FIG. 1.

To find the homologous positions in lipase sequences not shown in the alignment, the sequence of interest is aligned to the sequences shown in FIG. 1. The new sequence is aligned to the present alignment in FIG. 1 by using the GAP alignment to the most homologous sequence found by the GAP program. GAP is provided in the GCG program package (Program Manual for the Wisconsin Package, Version 8, August 1994, Genetics Computer Group, 575 Science Drive, Madison, Wis., USA 53711) (Needleman, S. B. and Wunsch, C. D., (1970), Journal of Molecular Biology, 48, 443-45). The following settings are used for polypeptide sequence comparison: GAP creation penalty of 3.0 and GAP extension penalty of 0.1.

Parent Lipases

Any suitable lipolytic enzyme may be used as a parent lipolytic enzyme also termed parent lipase. In some embodiments the lipolytic enzyme may be a fungal lipolytic enzyme.

The lipolytic enzyme may be a yeast lipolytic enzyme originating from genera such as a Candida, Kluyveromyces, Pichia, Saccharomyces, Schizosaccharomyces, or Yarrowia; or more preferably a filamentous fungal lipolytic enzyme originating from genera such as a Acremonium, Aspergillus, Aureobasidium, Cryptococcus, Filobasidium, Fusarium, Humicola, Magnaporthe, Mucor, Myceliophthora, Neocallimastix, Neurospora, Paecilomyces, Penicillium, Piromyces, Schizophyllum, Talaromyces, Thermoascus, Thielavia, Tolypocladium, Thermomyces or Trichoderma.

The lipolytic enzyme may furthermore be a Saccharomyces carlsbergensis, Saccharomyces cerevisiae, Saccharomyces diastaticus, Saccharomyces douglasii, Saccharomyces kluyveri, Saccharomyces norbensis, or Saccharomyces oviformis lipolytic enzyme.

Alternatively, the lipolytic enzyme is an Aspergillus aculeatus, Aspergillus awamori, Aspergillus fumigatus, Aspergillus foetidus, Aspergillus japonicus, Aspergillus nidulans, Aspergillus niger, Aspergillus oryzae, Aspergillus turbigensis, Fusarium bactridioides, Fusarium cerealis, Fusarium crookwellense, Fusarium culmorum, Fusarium graminearum, Fusarium graminum, Fusarium heterosporum, Fusarium negundi, Fusarium oxysporum, Fusarium reticulatum, Fusarium roseum, Fusarium sambucinum, Fusarium sarcochroum, Fusarium sporotrichioides, Fusarium sulphureum, Fusarium torulosum, Fusarium trichothecioides, Fusarium venenatum, Humicola insolens, Thermomyces lanoginosus (synonym: Humicola lanuginose), Mucor miehei, Myceliophthora thermophila, Neurospora crassa, Penicillium purpurogenum, Trichoderma harzianum, Trichoderma koningii, Trichoderma longibrachiatum, Trichoderma reesei, or Trichoderma viride lipolytic enzyme.

In some embodiments the invention relates to a lipolytic enzyme variant which is a Thermomyces lipase or a Thermomyces lanuginosus lipase.

In some embodiments the invention relates to a lipolytic enzyme variant, wherein the variant is at least 50%, at least 60%, at least 70%, at least 80%, at least 85%, at least 90%, at least 91%, at least 92%, at least 93%, at least 94%, at least 95%, at least 96%, at least 97%, at least 98%, at least 99% or 100% identical to SEQ ID NO:2.

Alterations in Lipolytic Enzyme Variants Having Improved In-Detergent Stability.

The positions referred to below are the positions of the amino acid residues in SEQ ID NO: 2. In the paragraph “Homology and alignment” a procedure of how to find the corresponding or homologous position of the amino acid residue in a different lipase is described.

The lipolytic enzyme variants, lipolytic variants, or in short variants, have according to the present invention surprisingly been found to be more in-detergent stable than the parent lipolytic enzyme. In-detergent stability is defined as the quality of retaining the lipolytic/lipase activity in the presence of detergent. The lipase activity may be fully or partly retained. Thus, variants of the invention show an improved ability to retain, either fully or partly, their lipase activity in the presence of detergent in comparison with parent lipases from which they are derived.

The term “lipase activity” as used herein means a carboxylic ester hydrolase activity which catalyses the hydrolysis of triacylglycerol under the formation of diacylglycerol and a carboxylate. For the purpose of the present invention, lipase activity is determined according to the following procedure: A substrate for lipase is prepared by emulsifying tributyrin (glycerin tributyrate) using gum Arabic as emulsifier. The hydrolysis of tributyrin at 30° C. at pH 7 or 9 is followed in a pH-stat titration experiment. One unit of lipase activity (1 LU) is defined as the amount of enzyme capable of releasing 1 micro mol of butyric acid per minute at 30° C., pH 7.

In some embodiments the variants according to the invention have been compared with a reference enzyme. The term “reference enzyme” or “reference lipase” as used herein means the mature part of SEQ ID NO: 2 with the substitutions T231R+N233R unless otherwise stated.

In some embodiments the invention relates to a variant of a parent lipolytic enzyme, wherein the variant: (a) has an amino acid sequence which compared to the parent lipolytic enzyme comprises substitution of an amino acid residue corresponding to any of amino acids 27, 216, 227, 231, 233 and 256 of SEQ ID NO: 2; and (b) is more in-detergent stable than the parent lipolytic enzyme.

In some embodiments the invention relates to a variant of a parent lipolytic enzyme, wherein the variant: (a) comprises the amino acid residues 231 and 233, and has an amino acid sequence which compared to the parent lipolytic enzyme comprises substitution of at least one amino acid residue corresponding to any of amino acids 27, 216, 227 and 256 of SEQ ID NO: 2; and (b) is more in-detergent stable than the parent lipolytic enzyme.

In some embodiments the invention relates to a variant of a parent lipolytic enzyme, wherein the variant having alterations of the amino acids at the positions 231+233 and one of: (a) 27; (b) 216; or (c) 256; optionally said variant furthermore comprises 227; which positions are corresponding to SEQ ID NO: 2.

In some embodiments the invention relates to a variant wherein the substitution of an amino acid residue is one of 27R, 216P, 227G, 231R, 233R or 256K of SEQ ID NO: 2.

In some embodiments the invention relates to a variant, wherein the substitution of an amino acid residue is one of D27R, S216P, L227G, T231R, N233R or P256K of SEQ ID NO: 2.

In some embodiments the invention relates to a variant, which variant comprises substitutions selected from the group consisting of: (a) T231R+N233R+P256K; (b) L227G+T231R+N233R; (c) L227G+T231R+N233R+P256K; (d) D27R+T231R+N233R; (e) D27+T231R+N233R; and (f) S216P+T231R+N233R.

In some embodiments the invention relates to a variant, wherein the parent lipolytic enzyme is at least 50%, at least 60%, at least 70%, at least 75%, at least 80%, at least 85%, at least 90%, at least 91%, at least 92%, at least 93%, at least 94%, at least 95%, at least 96%, at least 97%, at least 98%, at least 99%, or 100% identical to SEQ ID NO: 2.

In some embodiments the invention relates to a variant, wherein the parent lipolytic enzyme is a lipase produced by Thermomyces lanuginosus DSM 4109 and having the amino acid sequence of SEQ ID. NO: 2.

In some embodiments the invention relates to a variant, wherein the detergent is in a liquid detergent.

TABLE 1
Alterations that may be comprised in the lipolytic enzyme variants

| Variant | Mutations in SEQ ID NO: 2 |
|---|---|
| 1 | T231R + N233R + P256K |
| 2 | L227G + T231R + N233R |
| 3 | L227G + T231R + N233R + P256K |
| 4 | D27R + T231R + N233R |
| 5 | D27R + L227G + T231R + N233R |
| 6 | S216P + T231R + N233R |
| 7 | I202L + E210G + T231R + N233R + I255A + P256K |
| 8 | E1N + A18K + V60K + I86V + A150G + E210A + L227G + |
| | T231R + N233R + P256K |
| 9 | E1L + D27K + V60K + I86V + A150G + S219P + L227G + |
| | T231R + N233R + P256K |
| 10 | E1N + S58A + V60S + S83T + A150G + L227G + T231R + |
| | N233R + I255A + P256K |
| 11 | E1N + S58T + V60K + I86V + D102A + T143S + A150G + |
| | L227G + T231R + N233R + I255A + P256K |
| 12 | E1N + S58A + V60S + I86V + K98I + E99K + D102A + |
| | T143S + A150G + S216P + L227G + T231R + N233R + |
| | I255A + P256K |
| 13 | S58A + V60S + S83T + A150A + L227G + T231R + |
| | N233R + I255A + P256K |

In some embodiments the invention relates to a formulation comprising the lipolytic enzyme variant.

In some embodiments the invention relates to a formulation, wherein said formulation may be a liquid formulation.

Polynucleotides, Expression vector, Host cell, Production of lipolytic enzyme variants.

In some embodiments the invention relates to an isolated polynucleotide encoding the lipolytic enzyme variants. Polynucleotides may hybridize under very low stringency conditions, preferably low stringency conditions, more preferably medium stringency conditions, more preferably medium-high stringency conditions, even more preferably high stringency conditions, and most preferably very high stringency conditions with (i) nucleotides 178 to 660 of SEQ ID NO: 1, (ii) the cDNA sequence contained in nucleotides 178 to 660 of SEQ ID NO: 1, (iii) a subsequence of (i) or (ii), or (iv) a complementary strand of (i), (ii), or (iii) (J. Sambrook, E. F. Fritsch, and T. Maniatis, 1989, Molecular Cloning, A Laboratory Manual, 2d edition, Cold Spring Harbor, N.Y.). A subsequence of SEQ ID NO: 1 contains at least 100 contiguous nucleotides or preferably at least 200 contiguous nucleotides. Moreover, the subsequence may encode a polypeptide fragment which has lipase activity.

For long probes of at least 100 nucleotides in length, very low to very high stringency conditions are defined as pre-hybridization and hybridization at 42° C. in 5×SSPE, 0.3% SDS, 200 ug/ml sheared and denatured salmon sperm DNA, and either 25% formamide for very low and low stringencies, 35% formamide for medium and medium-high stringencies, or 50% formamide for high and very high stringencies, following standard Southern blotting procedures for 12 to 24 hours optimally.

For long probes of at least 100 nucleotides in length, the carrier material is finally washed three times each for 15 minutes using 2×SSC, 0.2% SDS preferably at least at 45° C. (very low stringency), more preferably at least at 50° C. (low stringency), more preferably at least at 55° C. (medium stringency), more preferably at least at 60° C. (medium-high stringency), even more preferably at least at 65° C. (high stringency), and most preferably at least at 70° C. (very high stringency).

The isolated polynucleotide encoding the lipolytic enzyme variant, the nucleic acid construct comprising the polynucleotide, the recombinant expression vector comprising the nucleic acid construct, and the transformed host cell comprising the nucleic acid construct or the recombinant expression vector may all be obtained by methods known in the art.

Procedure for Obtaining In-Detergent Stable Lipolytic Enzyme Variants

Variants of lipolytic enzymes may be obtained by methods known in the art, such as site-directed mutagenesis, random mutagenesis or localized mutagenesis, e.g. as described in WO 9522615 or WO 0032758. In-detergent stable variants of a given parent lipolytic enzyme may be obtained by the following standard procedure:

Mutagenesis (error-prone, doped oligo, spiked oligo)

Primary Screening

Identification of more in-detergent stable mutants

Maintenance (glycerol culture, LB-Amp plates, Mini-Prep)

Streaking out on another assay plate - secondary screening

(1 degree higher then primary screening)

DNA Sequencing

Transformation into a host cell, such as e.g. Aspergillus

Cultivation in 100 ml scale, purification, DSC

In some embodiments the invention relates to a method of preparing the lipolytic enzyme variant comprising the steps: (a) cultivating the transformed host cell comprising the nucleic acid construct or the recombinant expression vector comprising the nucleotide acid construct under conditions conductive for the production of the lipolytic enzyme variant; and (b) recovering the lipolytic enzyme variant. The method may be practiced according to principles known in the art.

In some embodiments the invention relates to a method of producing the variant comprising the steps: (a) selecting a parent lipolytic enzyme; (b) in the parent lipolytic enzyme substituting at least one amino acid residue corresponding to any of 27, 216, 227, 231, 233 and 256 of SEQ ID NO: 2; (c) optionally, altering one or more amino acids other than those mentioned in (b); (d) preparing the variant resulting from steps (a)-(c); (e) testing the in-detergent stability of the variant; (f) selecting a variant having an increased in-detergent stability; and (g) producing the selected variant.

Uses

The variants according to the invention may be used analogous to the parent lipolytic enzymes, and for some purposes the variants may be preferred due to their improved in-detergent stability. Thus, in some embodiments the invention relates to use of the variant in the hydrolysis of a carboxylic acid ester, or in the hydrolysis, synthesis or interesterification of an ester.

In some embodiments the invention relates to use of the variant for the manufacture of an in-detergent stable formulation.

Compositions

Preferably, the compositions are enriched in the polypeptide as defined in the claims of the present invention. The term “enriched” indicates that the lipase activity of the composition has been increased, e.g., with an enrichment factor of 1.1.

The composition may comprise a polypeptide of the present invention as the major enzymatic component, e.g., a mono-component composition. Alternatively, the composition may comprise multiple enzymatic activities, such as an aminopeptidase, amylase, carbohydrase, carboxypeptidase, catalase, cellulase, chitinase, cutinase, cyclodextrin glycosyltransferase, deoxyribonuclease, esterase, alpha-galactosidase, beta-galactosidase, glucoamylase, alpha-glucosidase, beta-glucosidase, haloperoxidase, invertase, laccase, lipase, mannosidase, oxidase, pectinolytic enzyme, peptidoglutaminase, peroxidase, phytase, polyphenoloxidase, proteolytic enzyme, ribonuclease, transglutaminase, or xylanase. The additional enzyme(s) may be produced, for example, by a microorganism belonging to the genus Aspergillus, preferably Aspergillus aculeatus, Aspergillus awamori, Aspergillus fumigatus, Aspergillus foetidus, Aspergillus japonicus, Aspergillus nidulans, Aspergillus niger, or Aspergillus oryzae; Fusarium, preferably Fusarium bactridioides, Fusarium cerealis, Fusarium crookwellense, Fusarium culmorum, Fusarium graminearum, Fusarium graminum, Fusarium heterosporum, Fusarium negundi, Fusarium oxysporum, Fusarium reticulatum, Fusarium roseum, Fusarium sambucinum, Fusarium sarcochroum, Fusarium sulphureum, Fusarium toruloseum, Fusarium trichothecioides, or Fusarium venenatum; Humicola, preferably Humicola insolens or Humicola lanuginosa; or Trichoderma, preferably Trichoderma harzianum, Trichoderma koningii, Trichoderma longibrachiatum, Trichoderma reesei, or Trichoderma viride.

The compositions may be prepared in accordance with methods known in the art and may be in the form of a liquid or a dry composition. For instance, the polypeptide composition may be in the form of a granulate or a microgranulate. The polypeptide to be included in the composition may be stabilized in accordance with methods known in the art.

Detergent Ingredients

The composition typically comprises one or more detergent ingredients. As used herein detergent compositions include articles and cleaning and treatment compositions. As used herein, the term “cleaning and/or treatment composition” includes, unless otherwise indicated, tablet, granular or powder-form all-purpose or “heavy-duty” washing agents, especially laundry detergents; liquid, gel or paste-form all-purpose washing agents, especially the so-called heavy-duty liquid types; liquid fine-fabric detergents; hand dishwashing agents or light duty dishwashing agents, especially those of the high-foaming type; machine dishwashing agents, including the various tablet, granular, liquid and rinse-aid types for household and institutional use. The compositions can also be in unit dose packages, including those known in the art and those that are water soluble, water insoluble and/or water permeable.

The detergent composition of the present invention can comprise one or more lipase variant(s) of the present invention. In addition to the lipase variant(s), the detergent composition will further comprise a detergent ingredient. The non-limiting list of detergent ingredients illustrated hereinafter are suitable for use in the instant compositions and may be desirably incorporated in certain embodiments of the invention, for example to assist or enhance cleaning performance, for treatment of the substrate to be cleaned, or to modify the aesthetics of the cleaning composition as is the case with colorants, dyes or the like. The precise nature of these additional components, and levels of incorporation thereof, will depend on the physical form of the composition and the nature of the cleaning operation for which it is to be used. Suitable detergent ingredients include, but are not limited to, surfactants, builders, chelating agents, dye transfer inhibiting agents, dispersants, enzymes, and enzyme stabilizers, bleach activators, hydrogen peroxide, sources of hydrogen peroxide, preformed peracids, polymeric dispersing agents, brighteners, suds suppressors, dyes, anti-corrosion agents, tarnish inhibitors, perfumes, perfume microcapsules, softeners, carriers, hydrotropes, processing aids, solvents and/or pigments.

Typical detergents would comprise by weight any combination of the following ingredients: 5-30% surfactant, preferably anionic surfactants such as linear alkylbenzenesulfonate and alcohol ethoxysulfate; 0.005-0.1% protease active protein, wherein the protease is preferably selected from Coronase™, FNA, FN4 or Savinase™, 0.001-0.1% amylase active protein, wherein the amylase is preferably selected from Termamyl™ Natalase™, Stainzyme™ and Purastar™ and 0.1-3% chelants, preferably diethylene triamine pentaacetic acid. For granular and tablet products, such typical detergents would additionally comprise by weight: 5-20% bleach, preferably sodium percarbonate; 1-4% bleach activator, preferably TAED and/or 0-30%, preferably 5-30%, more preferably less than 10% builder, such as the aluminosilicate Zeolite A and/or tripolyphosphate.

Bleaching Agents—The detergent compositions of the present invention may comprise one or more bleaching agents.

In general, when a bleaching agent is used, the compositions of the present invention may comprise from about 0.1% to about 50% or even from about 0.1% to about 25% bleaching agent by weight of the subject cleaning composition. Examples of suitable bleaching agents include:

(1) sources of hydrogen peroxide, for example, inorganic perhydrate salts, including alkali metal salts such as sodium salts of perborate (usually mono- or tetra-hydrate), percarbonate, persulphate, perphosphate, persilicate salts and mixtures thereof. In one aspect of the invention the inorganic perhydrate salts are selected from the group consisting of sodium salts of perborate, percarbonate and mixtures thereof.

(2) bleach activators having R—(C═O)-L wherein R is an alkyl group, optionally branched, having, when the bleach activator is hydrophobic, from 6 to 14 carbon atoms, or from 8 to 12 carbon atoms and, when the bleach activator is hydrophilic, less than 6 carbon atoms or even less than 4 carbon atoms; and L is leaving group. Examples of suitable leaving groups are benzoic acid and derivatives thereof—especially benzene sulphonate. Suitable bleach activators include dodecanoyl oxybenzene sulphonate, decanoyl oxybenzene sulphonate, decanoyl oxybenzoic acid or salts thereof, 3,5,5-trimethyl hexanoyloxybenzene sulphonate, tetraacetyl ethylene diamine (TAED) and nonanoyloxybenzene sulphonate (NOBS). Suitable bleach activators are also disclosed in WO 98/17767. While any suitable bleach activator may be employed, in one aspect of the invention the subject cleaning composition may comprise NOBS, TAED or mixtures thereof.

(3) Pre-formed peracids.

When present, the peracid and/or bleach activator is generally present in the composition in an amount of from about 0.1 to about 60 wt %, from about 0.5 to about 40 wt % or even from about 0.6 to about 10 wt % based on the composition. One or more hydrophobic precursors thereof may be used in combination with one or more hydrophilic peracid or precursor thereof.

The amounts of hydrogen peroxide source and peracid or bleach activator may be selected such that the molar ratio of available oxygen (from the peroxide source) to peracid is from 1:1 to 35:1, or even 2:1 to 10:1.

Surfactants—The detergent compositions according to the present invention may comprise a surfactant or surfactant system wherein the surfactant can be selected from nonionic surfactants, anionic surfactants, cationic surfactants, ampholytic surfactants, zwitterionic surfactants, semi-polar nonionic surfactants and mixtures thereof. When present, surfactant is typically present at a level of from about 0.1% to about 60%, from about 0.1% to about 40%, from about 0.1% to about 12%, from about 1% to about 50% or even from about 5% to about 40% by weight of the subject composition.

When included therein the detergent will usually contain from about 1% to about 40% of an anionic surfactant such as linear alkylbenzenesulfonate, alpha-olefinsulfonate, alkyl sulfate (fatty alcohol sulfate), alcohol ethoxysulfate, secondary alkanesulfonate, alpha-sulfo fatty acid methyl ester, alkyl- or alkenylsuccinic acid or soap.

The detergent may optionally contain from about 0.2% to about 40% of a non-ionic surfactant such as alcohol ethoxylate, nonylphenol ethoxylate, alkylpolyglycoside, alkyldimethylamineoxide, ethoxylated fatty acid monoethanolamide, fatty acid monoethanolamide, polyhydroxy alkyl fatty acid amide, or N-acyl N-alkyl derivatives of glucosamine (“glucamides”).

Builders—The detergent compositions of the present invention may comprise one or more detergent builders or builder systems. When a builder is used, the subject composition will typically comprise at least about 1%, from about 5% to about 60% or even from about 10% to about 40% builder by weight of the subject composition.

The detergent composition may comprise: (a) from 0 wt % to 10 wt %, preferably from 0 wt % to 5 wt % zeolite builder; (b) from 0 wt % to 10 wt %, preferably from 0 wt % to 5 wt % phosphate builder; and (c) optionally, from 0 wt % to 5 wt % silicate salt.

Builders include, but are not limited to, the alkali metal, ammonium and alkanolammonium salts of polyphosphates, alkali metal silicates or layered silicates, alkaline earth and alkali metal carbonates, aluminosilicate builders and the various alkali metal, ammonium and substituted ammonium salts of polyacetic acids such as ethylenediamine tetraacetic acid and nitrilotriacetic acid, as well as polycarboxylates such as mellitic acid, succinic acid, citric acid, oxydisuccinic acid, polymaleic acid, benzene 1,3,5-tricarboxylic acid, carboxymethyloxysuccinic acid, and soluble salts thereof.

Chelating Agents—The detergent compositions herein may contain a chelating agent. Suitable chelating agents include copper, iron and/or manganese chelating agents and mixtures thereof. When a chelating agent is used, the subject composition may comprise from about 0.005% to about 15% or even from about 3.0% to about 10% chelating agent by weight of the subject composition.

Amine compound—Preferably, the composition comprises a compound having the following general structure: bis((C₂H₅O)(C₂H₄O)n)(CH₃)—N⁺—CₓH₂ₓ—N⁺—(CH₃)-bis((C₂H₅O)(C₂H₄O)n), wherein n=from 20 to 30, and x=from 3 to 8, or sulphated or sulphonated variants thereof.

Brighteners—The detergent compositions of the present invention can also contain additional components that may alter appearance of articles being cleaned, such as fluorescent brighteners. These brighteners absorb in the UV-range and emit in the visible. Suitable fluorescent brightener levels include lower levels of from about 0.01, from about 0.05, from about 0.1 or even from about 0.2 wt % to upper levels of 0.5 or even 0.75 wt %.

Dispersants—The compositions of the present invention can also contain dispersants. Suitable water-soluble organic materials include the homo- or co-polymeric acids or their salts, in which the polycarboxylic acid comprises at least two carboxyl radicals separated from each other by not more than two carbon atoms.

Enzymes—In addition to the lipase variant(s) of the present invention the detergent composition can comprise one or more further enzymes which provide cleaning performance and/or fabric care benefits such as a protease, another lipase, a cutinase, an amylase, a carbohydrase, a cellulase, a pectinase, a mannanase, an arabinase, a galactanase, a xylanase, an oxidase, e.g., a laccase, and/or a peroxidase.

In general the properties of the chosen enzyme(s) should be compatible with the selected detergent, (i.e. pH-optimum, compatibility with other enzymatic and non-enzymatic ingredients, etc.), and the enzyme(s) should be present in effective amounts.

Suitable proteases include those of animal, vegetable or microbial origin. Microbial origin is preferred. Chemically modified or protein engineered mutants are included. The protease may be a serine protease or a metallo protease, preferably an alkaline microbial protease or a trypsin-like protease. Examples of alkaline proteases are subtilisins, especially those derived from Bacillus, e.g., subtilisin Novo, subtilisin Carlsberg, subtilisin 309, subtilisin 147 and subtilisin 168 (described in WO 89/06279), SEQ ID no 4 and SEQ ID no 7 in WO 05/103244. Other suitable serine proteases include those from Micrococcineae spp especially Cellulonas spp and variants thereof as disclosured in WO2005052146. Examples of trypsin-like proteases are trypsin (e.g. of porcine or bovine origin) and the Fusarium protease described in WO 89/06270 and WO 94/25583.

Examples of useful proteases are the variants described in WO 92/19729, WO 98/20115, WO 98/20116, and WO 98/34946, especially the variants with substitutions in one or more of the following positions: 27, 36, 57, 68, 76, 87, 97, 101, 104, 106, 120, 123, 167, 170, 194, 206, 218, 222, 224, 235, 245, 252 and 274, and amongst other variants with the following mutations: (K27R, V104Y, N123S, T124A), (N76D, S103A, V104I), or (S101G, S103A, V1041, G159D, A232V, Q236H, Q245R, N248D, N252K). Other examples of useful proteases are the variants described in WO 05/052146 especially the variants with substitutions in one or more of the following positions: 14, 16, 35, 65, 75, 76, 79, 123, 127, 159 and 179.

Preferred commercially available protease enzymes include Alcalase™, Savinase™, Primase™, Duralase™, Esperase™, Coronase™, Polarzyme™ and Kannase™ (Novozymes A/S), Maxatase™, Maxacal™, Maxapem™, Properase™, Purafect™, Purafect Prime™, Purafect OxP™, FNA, FN2, FN3 and FN4 (Genencor International Inc.).

Lipases include those of bacterial or fungal origin. Chemically modified or protein engineered mutants are included. Examples of useful lipases include lipases from Humicola (synonym Thermomyces), e.g. from H. lanuginosa (synonymous T. lanuginosus) as described in EP 258 068 and EP 305 216 or from H. insolens as described in WO 96/13580, a Pseudomonas lipase, e.g. from P. alcaligenes or P. pseudoalcaligenes (EP 218 272), P. cepacia (EP 331 376), P. stutzeri (GB 1,372,034), P. fluorescens, Pseudomonas sp. strain SD 705 (WO 95/06720 and WO 96/27002), P. wisconsinensis (WO 96/12012), a Bacillus lipase, e.g. from B. subtilis (Dartois et al. (1993), Biochemica et Biophysica Acta, 1131, 253-360), B. stearothermophilus (JP 64/744992) or B. pumilus (WO 91/16422).

Other examples are lipase variants such as those described in WO 92/05249, WO 94/01541, EP 407 225, EP 260 105, WO 95/35381, WO 96/00292, WO 95/30744, WO 94/25578, WO 95/14783, WO 95/22615, WO 97/04079 and WO 97/07202. Other commercially available lipase enzymes include Lipolase™, Lipolase Ultra™ and Lipex™ (Novozymes A/S).

Suitable amylases (α and/or β) include those of bacterial or fungal origin. Chemically modified or protein engineered mutants are included. Amylases include, for example, α-amylases obtained from Bacillus, e.g. a special strain of B. licheniformis, described in more detail in GB 1,296,839.

Examples of useful amylases are the variants described in WO 94/02597, WO 94/18314, WO 96/23873, and WO 97/43424, especially the variants with substitutions in one or more of the following positions: 15, 23, 105, 106, 124, 128, 133, 154, 156, 181, 188, 190, 197, 202, 208, 209, 243, 264, 304, 305, 391, 408, and 444.

Commercially available amylases are Duramyl™, Termamyl™, Stainzyme™, Stainzyme Ultra™, Stainzyme Plus™, Fungamyl™ and BAN™ (Novozymes A/S), Rapidase™ and Purastar™ (from Genencor International Inc.).

Suitable cellulases include those of bacterial or fungal origin. Chemically modified or protein engineered mutants are included. Suitable cellulases include cellulases from the genera Bacillus, Pseudomonas, Humicola, Fusarium, Thielavia, Acremonium, e.g. the fungal cellulases produced from Humicola insolens, Myceliophthora thermophila and Fusarium oxysporum disclosed in U.S. Pat. No. 4,435,307, U.S. Pat. No. 5,648,263, U.S. Pat. No. 5,691,178, U.S. Pat. No. 5,776,757 and WO 89/09259.

Especially suitable cellulases are the alkaline or neutral cellulases having colour care benefits. Examples of such cellulases are cellulases described in EP 0 495 257, EP 0 531 372, WO 96/11262, WO 96/29397, WO 98/08940. Other examples are cellulase variants such as those described in WO 94/07998, EP 0 531 315, U.S. Pat. No. 5,457,046, U.S. Pat. No. 5,686,593, U.S. Pat. No. 5,763,254, WO 95/24471, WO 98/12307 and PCT/DK98/00299.

Commercially available cellulases include Renozyme™, Celluclean™, Endolase™, Celluzyme™, and Carezyme™ (Novozymes A/S), Clazinase™, and Puradax HA™ (Genencor International Inc.), and KAC-500(B)™ (Kao Corporation).

Peroxidases/Oxidases:

Suitable peroxidases/oxidases include those of plant, bacterial or fungal origin. Chemically modified or protein engineered mutants are included. Examples of useful peroxidases include peroxidases from Coprinus, e.g. from C. cinereus, and variants thereof as those described in WO 93/24618, WO 95/10602, and WO 98/15257.

Commercially available peroxidases include Guardzyme™ (Novozymes A/S).

When present in a cleaning composition, the aforementioned enzymes may be present at levels from about 0.00001% to about 2%, from about 0.0001% to about 1% or even from about 0.001% to about 0.5% enzyme protein by weight of the composition.

Enzyme Stabilizers—Enzymes for use in detergents can be stabilized by various techniques. The enzymes employed herein can be stabilized by the presence of water-soluble sources of calcium and/or magnesium ions in the finished compositions that provide such ions to the enzymes. Further conventional stabilizing agents, e.g., a polyol such as propylene glycol or glycerol, a sugar or sugar alcohol, lactic acid, boric acid, or a boric acid derivative, e.g., an aromatic borate ester, or a phenyl boronic acid derivative such as 4-formylphenyl boronic acid, may also be used and the composition may be formulated as described in e.g. WO 92/19709 and WO 92/19708.

Solvents—Suitable solvents include water and other solvents such as lipophilic fluids. Examples of suitable lipophilic fluids include siloxanes, other silicones, hydrocarbons, glycol ethers, glycerine derivatives such as glycerine ethers, perfluorinated amines, perfluorinated and hydrofluoroether solvents, low-volatility nonfluorinated organic solvents, diol solvents, other environmentally-friendly solvents and mixtures thereof.

Photobleach—The composition may comprise a photobleach. Preferably the photobleach is selected from xanthene dye photobleach, a photo-initiator and mixtures thereof.

Suitable photobleaches include catalytic photobleaches and photo-initiators. Suitable catalytic photobleaches include catalytic photobleaches selected from the group consisting of water soluble phthalocyanines of the formula:

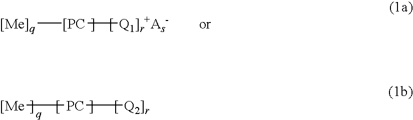

in which:
PC is the phthalocyanine ring system;
Me is Zn; Fe(II); Ca; Mg; Na; K; Al-Z₁; Si(IV) ; P(V); Ti(IV); Ge(IV); Cr(VI); Ga(III); Zr(IV); In(III); Sn(IV) or Hf(VI)

Z₁ is a halide; sulfate; nitrate; carboxylate; alkanolate; or hydroxyl ion;
q is 0; 1 or 2;
r is 1 to 4;
Q₁, is a sulfo or carboxyl group; or a radical of the formula

—SO₂X₂—R₁—X₃⁺; —O—R₁—X₃⁺; or —(CH₂),—Y₁^{+;}
in which
   R₁ is a branched or unbranched C₁-C₈ alkylene; or 1,3- or 1,4-phenylene;
   X₂ is —NH—; or —N—C₁-C₅ alkyl;
   X₃⁺ is a group of the formula

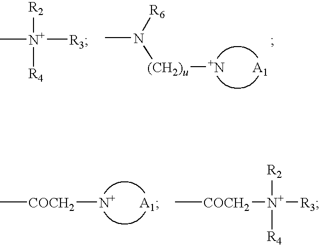

or, in the case where R₁═C₁-C₈alkylene, also a group of the formula

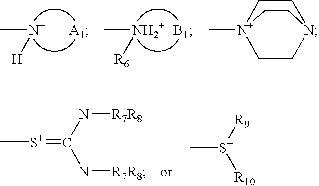

Y₁⁺ is a group of the formula

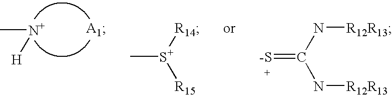

t is 0 or 1

where in the above formulae

R₂ and R₃ independently of one another are C₁-C₆ alkyl

R₄ is C₁-C₅ alkyl; C₅-C₇ cycloalkyl or NR₇R₈;

R₅ and R₆ independently of one another are C₁-C₅ alkyl;

R₇ and R₈ independently of one another are hydrogen or C₁-C₅ alkyl;

R₉ and R₁₀ independently of one another are unsubstituted C₁-C₆ alkyl or C₁-C₆ alkyl substituted by hydroxyl, cyano, carboxyl, carb-C₁-C₆ alkoxy, C₁-C₆ alkoxy, phenyl, naphthyl or pyridyl;

u is from 1 to 6;

A₁ is a unit which completes an aromatic 5- to 7-membered nitrogen heterocycle, which may where appropriate also contain one or two further nitrogen atoms as ring members, and

B₁ is a unit which completes a saturated 5- to 7-membered nitrogen heterocycle, which may where appropriate also contain 1 to 2 nitrogen, oxygen and/or sulfur atoms as ring members;

Q₂ is hydroxyl; C₁-C₂₂ alkyl; branched C₃-C₂₂ alkyl; C₂- C₂₂ alkenyl; branched C₃-C₂₂ alkenyl and mixtures thereof; C₁-C₂₂ alkoxy; a sulfo or carboxyl radical; a radical of the formula

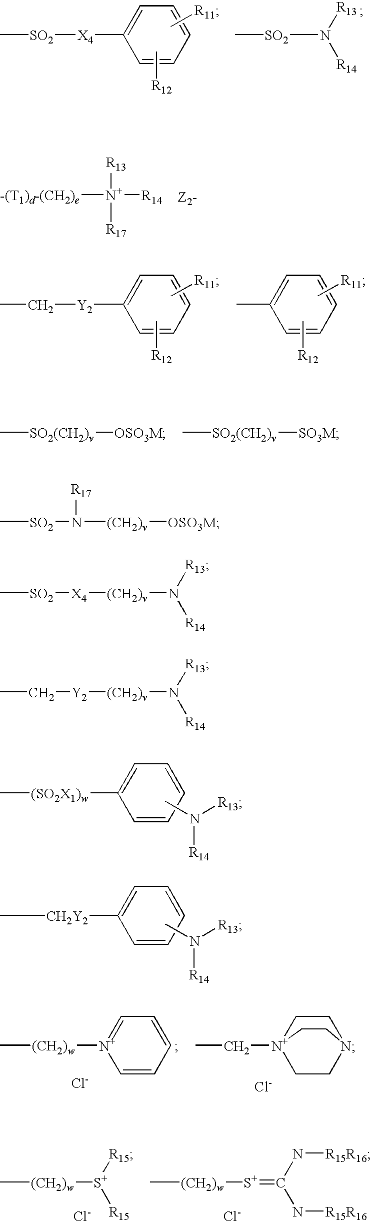

a branched alkoxy radical of the formula

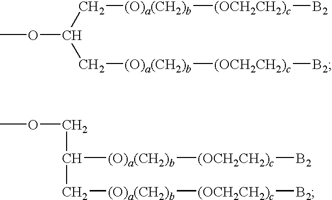

an alkylethyleneoxy unit of the formula

-(T₁)_{d}—(CH₂)_{b}(OCH₂CH₂)_{B}—B₃

or an ester of the formula

COOR₁₈

in which

B₂ is hydrogen; hydroxyl; C₁-C₃₀ alkyl; C₁-C₃₀ alkoxy; —CO₂H; —CH₂COOH; —SO₃-M₁; —OSO₃-M₁; —PO₃²⁻M; —OPO₃²⁻M₁; and mixtures thereof;

B₃ is hydrogen; hydroxyl; —COOH; —SO₃-M₁; —OSO₃ M₁ or C₁-C₆ alkoxy;

M₁ is a water-soluble cation;

T₁ is —O—; or —NH—;

X₁ and X₄ independently of one another are —O—; —NH— or —N—C₁-C₅alkyl;

R₁₁ and R₁₂ independently of one another are hydrogen; a sulfo group and salts thereof; a carboxyl group and salts thereof or a hydroxyl group; at least one of the radicals R₁₁ and R₁₂ being a sulfo or carboxyl group or salts thereof,

Y₂ is —O—; —S—; —NH— or —N—C₁-C₅alkyl;

R₁₃ and R₁₄ independently of one another are hydrogen; C₁-C₆ alkyl; hydroxy-C₁-C₆ alkyl; cyano-C₁-C₆ alkyl; sulfo-C₁-C₆ alkyl; carboxy or halogen-C₁-C₆ alkyl; unsubstituted phenyl or phenyl substituted by halogen, C₁-C₄ alkyl or C₁-C₄ alkoxy; sulfo or carboxyl or R₁₃ and R₁₄ together with the nitrogen atom to which they are bonded form a saturated 5- or 6-membered heterocyclic ring which may additionally also contain a nitrogen or oxygen atom as a ring member;

R₁₅ and R₁₆ independently of one another are C₁-C₆ alkyl or aryl-C₁-C₆ alkyl radicals;

R₁₇ is hydrogen; an unsubstituted C₁-C₆ alkyl or C₁-C₆ alkyl substituted by halogen, hydroxyl, cyano, phenyl, carboxyl, carb-C₁-C₆ alkoxy or C₁-C₆ alkoxy;

R₁₈ is C₁-C₂₂ alkyl; branched C₃-C₂₂ alkyl; C₁-C₂₂ alkenyl or branched C₃-C₂₂ alkenyl; C₃-C₂₂ glycol; C₁-C₂₂ alkoxy; branched C₃-C₂₂ alkoxy; and mixtures thereof;

M is hydrogen; or an alkali metal ion or ammonium ion,

Z₂⁻ is a chlorine; bromine; alkylsulfate or arylsulfate ion;

a is 0 or 1;

b is from 0 to 6;

c is from 0 to 100;

d is 0; or 1;

e is from 0 to 22;

v is an integer from 2 to 12;

w is 0 or 1; and

A⁻ is an organic or inorganic anion, and

s is equal to r in cases of monovalent anions A⁻ and less than or equal to r in cases of polyvalent anions, it being necessary for Aₛ⁻ to compensate the positive charge; where, when r is not equal to 1, the radicals Q₁ can be identical or different,

and where the phthalocyanine ring system may also comprise further solubilising groups;

Other suitable catalytic photobleaches include xanthene dyes and mixtures thereof. In another aspect, suitable catalytic photobleaches include catalytic photobleaches selected from the group consisting of sulfonated zinc phthalocyanine, sulfonated aluminium phthalocyanine, Eosin Y, Phoxine B, Rose Bengal, C.I. Food Red 14 and mixtures thereof. In another aspect a suitable photobleach may be a mixture of sulfonated zinc phthalocyanine and sulfonated aluminium phthalocyanine, said mixture having a weight ratio of sulfonated zinc phthalocyanine to sulfonated aluminium phthalocyanine greater than 1, greater than I but less than about 100, or even from about 1 to about 4.

Suitable photo-initiators include photo-initiators selected from the group consisting of Aromatic 1,4-quinones such as anthraquinones and naphthaquinones; Alpha amino ketones, particularly those containing a benzoyl moiety, otherwise called alpha-amino acetophenones; Alphahydroxy ketones, particularly alpha-hydroxy acetophenones; Phosphorus-containing photoinitiators, including monoacyl, bisacyl and trisacyl phosphine oxide and sulphides; Dialkoxy acetophenones; Alpha-haloacetophenones; Trisacyl phosphine oxides; Benzoin and benzoin based photoinitiators, and mixtures thereof. In another aspect, suitable photo-initiators include photo-initiators selected from the group consisting of 2-ethyl anthraquinone; Vitamin K3; 2-sulphate-anthraquinone; 2-methyl 1-[4-phenyl]-2-morpholinopropan-1-one (Irgacure® 907); (2-benzyl-2-dimethyl amino-1-(4-morpholinophenyl)-butan-1-one (Irgacure® 369); (1-[4-(2-hydroxyethoxy)-phenyl]-2 hydroxy-2-methyl-1-propan-1-one) (Irgacure® 2959); 1-hydroxy-cyclohexyl-phenyl-ketone (Irgacure® 184); oligo[2-hydroxy 2-methyl-1-[4(1-methyl)-phenyl]propanone (Esacure® KIP 150); 2-4-6-(trimethylbenzoyl)diphenyl-phosphine oxide, bis(2,4,6-trimethylbenzoyl)-phenyl-phosphine oxide (Irgacure® 819); (2,4,6 trimethylbenzoyl)phenyl phosphinic acid ethyl ester (Lucirin® TPO-L); and mixtures thereof.

The aforementioned photobleaches can be used in combination (any mixture of photobleaches can be used). Suitable photobleaches can be purchased from Aldrich, Milwaukee, Wis., USA; Frontier Scientific, Logan, Utah, USA; Ciba Specialty Chemicals, Basel, Switzerland; BASF, Ludwigshafen, Germany; Lamberti S.p.A, Gallarate, Italy; Dayglo Color Corporation, Mumbai, India; Organic Dyestuffs Corp., East Providence, R.I., USA; and/or made in accordance with the examples contained herein.

Fabric hueing agent—the composition comprises a fabric hueing agent. Fabric hueing agents can alter the tint of a surface as they absorb at least a portion of the visible light spectrum.

Suitable fabric hueing agents include dyes, dye-clay conjugates, and pigments that satisfy the requirements of Test Method 1 described in more detail in WO2007/087257, detailed on pages 15 and 16 therein and incorporated herein by reference. Suitable dyes include small molecule dyes and polymeric dyes. Suitable small molecule dyes include small molecule dyes selected from the group consisting of dyes falling into the Colour Index (C.I.) classifications of Direct Blue, Direct Red, Direct Violet, Acid Blue, Acid Red, Acid Violet, Basic Blue, Basic Violet and Basic Red, or mixtures thereof, for example:

(1) Tris-azo direct blue dyes of the formula

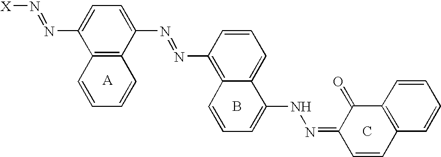

where at least two of the A, B and C napthyl rings are substituted by a sulfonate group, the C ring may be substituted at the 5 position by an NH₂ or NHPh group, X is a benzyl or naphthyl ring substituted with up to 2 sulfonate groups and may be substituted at the 2 position with an OH group and may also be substituted with an NH₂ or NHPh group.

(2) bis-azo Direct violet dyes of the formula:

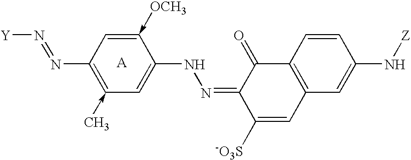

where Z is H or phenyl, the A ring is preferably substituted by a methyl and methoxy group at the positions indicated by arrows, the A ring may also be a naphthyl ring, the Y group is a benzyl or naphthyl ring, which is substituted by sulfate group and may be mono or disubstituted by methyl groups.

(3) Blue or red acid dyes of the formula

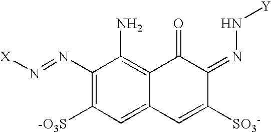

where at least one of X and Y must be an aromatic group. In one aspect, both the aromatic groups may be a substituted benzyl or naphthyl group, which may be substituted with non water-solubilising groups such as alkyl or alkyloxy or aryloxy groups, X and Y may not be substituted with water solubilising groups such as sulfonates or carboxylates. In another aspect, X is a nitro substituted benzyl group and Y is a benzyl group

(4) Red acid dyes of the structure

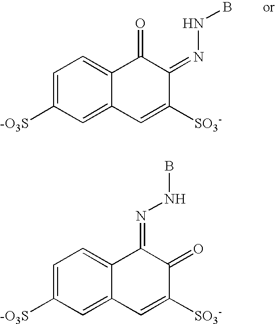

where B is a naphthyl or benzyl group that may be substituted with non water solubilising groups such as alkyl or alkyloxy or aryloxy groups, B may not be substituted with water solubilising groups such as sulfonates or carboxylates.

(5) Dis-azo dyes of the structure

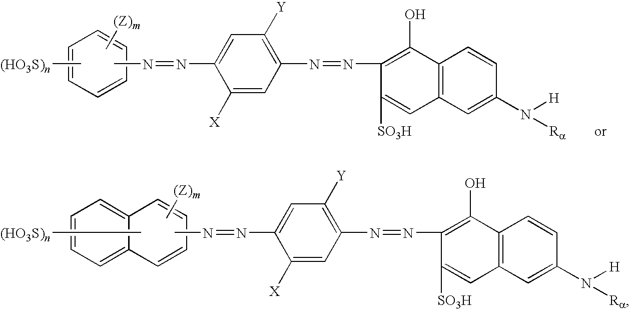

wherein X and Y, independently of one another, are each hydrogen, C₁-C₄ alkyl or C₁-C₄-alkoxy, Rα is hydrogen or aryl, Z is C₁-C₄ alkyl; C₁-C₄-alkoxy; halogen; hydroxyl or carboxyl, n is 1 or 2 and m is 0, 1 or 2, as well as corresponding salts thereof and mixtures thereof

(6) Triphenylmethane dyes of the following structures

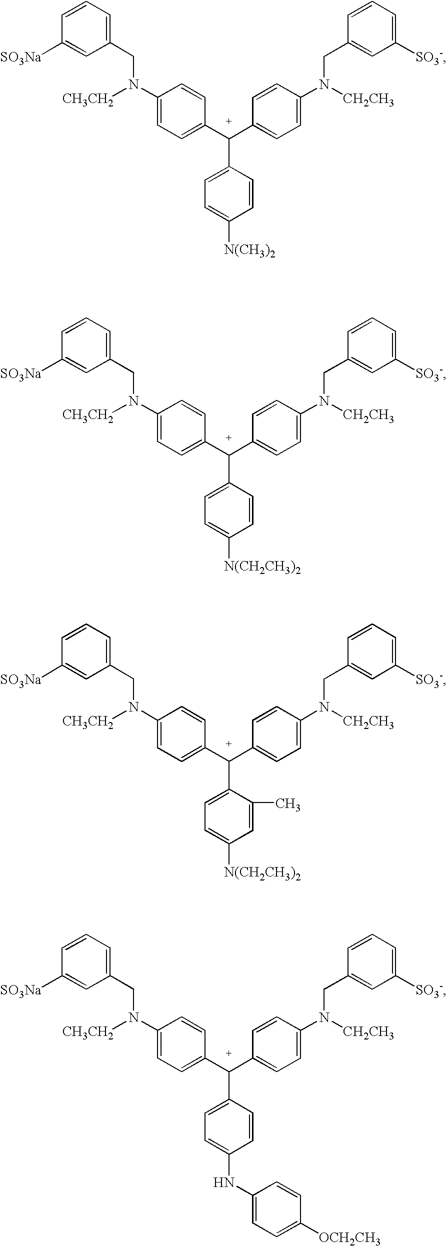

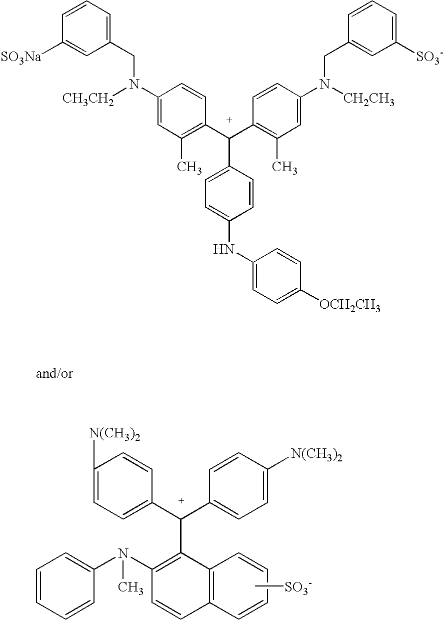

and mixtures thereof. In another aspect, suitable small molecule dyes include small molecule dyes selected from the group consisting of Colour Index (Society of Dyers and Colourists, Bradford, UK) numbers Direct Violet 9, Direct Violet 35, Direct Violet 48, Direct Violet 51, Direct Violet 66, Direct Blue 1, Direct Blue 71, Direct Blue 80, Direct Blue 279, Acid Red 17, Acid Red 73, Acid Red 88, Acid Red 150, Acid Violet 15, Acid Violet 17, Acid Violet 24, Acid Violet 43, Acid Red 52, Acid Violet 49, Acid Blue 15, Acid Blue 17, Acid Blue 25, Acid Blue 29, Acid Blue 40, Acid Blue 45, Acid Blue 75, Acid Blue 80, Acid Blue 83, Acid Blue 90 and Acid Blue 113, Acid Black 1, Basic Violet 1, Basic Violet 3, Basic Violet 4, Basic Violet 10, Basic Violet 35, Basic Blue 3, Basic Blue 16, Basic Blue 22, Basic Blue 47, Basic Blue 66, Basic Blue 75, Basic Blue 159 and mixtures thereof. In another aspect, suitable small molecule dyes include small molecule dyes selected from the group consisting of Colour Index (Society of Dyers and Colourists, Bradford, UK) numbers Acid Violet 17, Acid Violet 43, Acid Red 52, Acid Red 73, Acid Red 88, Acid Red 150, Acid Blue 25, Acid Blue 29, Acid Blue 45, Acid Blue 113, Acid Black 1, Direct Blue 1, Direct Blue 71, Direct Violet 51 and mixtures thereof. In another aspect, suitable small molecule dyes include small molecule dyes selected from the group consisting of Colour Index (Society of Dyers and Colourists, Bradford, UK) numbers Acid Violet 17, Direct Blue 71, Direct Violet 51, Direct Blue 1, Acid Red 88, Acid Red 150, Acid Blue 29, Acid Blue 113 or mixtures thereof.

Suitable polymeric dyes include polymeric dyes selected from the group consisting of polymers containing conjugated chromogens (dye-polymer conjugates) and polymers with chromogens co-polymerized into the backbone of the polymer and mixtures thereof.

In another aspect, suitable polymeric dyes include polymeric dyes selected from the group consisting of fabric-substantive colorants sold under the name of Liquitint® (Milliken, Spartanburg, S.C., USA), dye-polymer conjugates formed from at least one reactive dye and a polymer selected from the group consisting of polymers comprising a moiety selected from the group consisting of a hydroxyl moiety, a primary amine moiety, a secondary amine moiety, a thiol moiety and mixtures thereof. In still another aspect, suitable polymeric dyes include polymeric dyes selected from the group consisting of Liquitint® (Milliken, Spartanburg, S.C., USA) Violet CT, carboxymethyl cellulose (CMC) conjugated with a reactive blue, reactive violet or reactive red dye such as CMC conjugated with C.I. Reactive Blue 19, sold by Megazyme, Wicklow, Ireland under the product name AZO-CM-CELLULOSE, product code S-ACMC, alkoxylated triphenyl-methane polymeric colourants, alkoxylated thiophene polymeric colourants, and mixtures thereof.

Suitable dye clay conjugates include dye clay conjugates selected from the group comprising at least one cationic/basic dye and a smectite clay, and mixtures thereof. In another aspect, suitable dye clay conjugates include dye clay conjugates selected from the group consisting of one cationic/basic dye selected from the group consisting of C.I. Basic Yellow 1 through 108, C.I. Basic Orange 1 through 69, C.I. Basic Red 1 through 118, C.I. Basic Violet 1 through 51, C.I. Basic Blue 1 through 164, C.I. Basic Green 1 through 14, C.I. Basic Brown 1 through 23, CI Basic Black 1 through 11, and a clay selected from the group consisting of Montmorillonite clay, Hectorite clay, Saponite clay and mixtures thereof. In still another aspect, suitable dye clay conjugates include dye clay conjugates selected from the group consisting of: Montmorillonite Basic Blue B7 C.I. 42595 conjugate, Montmorillonite Basic Blue B9 C.I. 52015 conjugate, Montmorillonite Basic Violet V3 C.I. 42555 conjugate, Montmorillonite Basic Green G1 C.I. 42040 conjugate, Montmorillonite Basic Red R1 C.I. 45160 conjugate, Montmorillonite C.I. Basic Black 2 conjugate, Hectorite Basic Blue B7 C.I. 42595 conjugate, Hectorite Basic Blue B9 C.I. 52015 conjugate, Hectorite Basic Violet V3 C.I. 42555 conjugate, Hectorite Basic Green G1 C.I. 42040 conjugate, Hectorite Basic Red RI C.I. 45160 conjugate, Hectorite C.I. Basic Black 2 conjugate, Saponite Basic Blue B7 C.I. 42595 conjugate, Saponite Basic Blue B9 C.I. 52015 conjugate, Saponite Basic Violet V3 C.I. 42555 conjugate, Saponite Basic Green GI C.I. 42040 conjugate, Saponite Basic Red R1 C.I. 45160 conjugate, Saponite C.I. Basic Black 2 conjugate and mixtures thereof.

Suitable pigments include pigments selected from the group consisting of flavanthrone, indanthrone, chlorinated indanthrone containing from 1 to 4 chlorine atoms, pyranthrone, dichloropyranthrone, monobromodichloropyranthrone, dibromodichloropyranthrone, tetrabromopyranthrone, perylene-3,4,9,10-tetracarboxylic acid diimide, wherein the imide groups may be unsubstituted or substituted by C1-C3 -alkyl or a phenyl or heterocyclic radical, and wherein the phenyl and heterocyclic radicals may additionally carry substituents which do not confer solubility in water, anthrapyrimidinecarboxylic acid amides, violanthrone, isoviolanthrone, dioxazine pigments, copper phthalocyanine which may contain up to 2 chlorine atoms per molecule, polychloro-copper phthalocyanine or polybromochloro-copper phthalocyanine containing up to 14 bromine atoms per molecule and mixtures thereof.

In another aspect, suitable pigments include pigments selected from the group consisting of Ultramarine Blue (C.I. Pigment Blue 29), Ultramarine Violet (C.I. Pigment Violet 15) and mixtures thereof.

The aforementioned fabric hueing agents can be used in combination (any mixture of fabric hueing agents can be used). Suitable fabric hueing agents can be purchased from Aldrich, Milwaukee, Wis., USA; Ciba Specialty Chemicals, Basel, Switzerland; BASF, Ludwigshafen, Germany; Dayglo Color Corporation, Mumbai, India; Organic Dyestuffs Corp., East Providence, R.I., USA; Dystar, Frankfurt, Germany; Lanxess, Leverkusen, Germany; Megazyme, Wicklow, Ireland; Clariant, Muttenz, Switzerland; Avecia, Manchester, UK and/or made in accordance with the examples contained herein.

Suitable hueing agents are described in more detail in U.S. Pat. No. 7,208,459 B2.

Preferred fabric hueing agents are selected from Direct Violet 9, Direct Violet 99, Acid Red 52, Acid Blue 80 and mixtures thereof.

Bleach catalyst—typically, the bleach catalyst is capable of accepting an oxygen atom from a peroxyacid and/or salt thereof, and transferring the oxygen atom to an oxidizeable substrate. Suitable bleach catalysts include, but are not limited to: iminium cations and polyions; iminium zwitterions; modified amines; modified amine oxides; N-sulphonyl imines; N-phosphonyl imines; N-acyl imines; thiadiazole dioxides; perfluoroimines; cyclic sugar ketones and mixtures thereof.

Suitable iminium cations and polyions include, but are not limited to, N-methyl-3,4-dihydroisoquinolinium tetrafluoroborate, prepared as described in Tetrahedron (1992), 49(2), 423-38 (see, for example, compound 4, p. 433); N-methyl-3,4-dihydroisoquinolinium p-toluene sulphonate, prepared as described in U.S. Pat. No. 5,360,569 (see, for example, Column 11, Example 1); and N-octyl-3,4-dihydroisoquinolinium p-toluene sulphonate, prepared as described in U.S. Pat. No. 5,360,568 (see, for example, Column 10, Example 3).

Suitable iminium zwitterions include, but are not limited to, N-(3-sulfopropyl)-3,4-dihydroisoquinolinium, inner salt, prepared as described in U.S. Pat. No. 5,576,282 (see, for example, Column 31, Example II); N-[2-(sulphooxy)dodecyl]-3,4-dihydroisoquinolinium, inner salt, prepared as described in U.S. Pat. No. 5,817,614 (see, for example, Column 32, Example V); 2-[3-[(2-ethylhexyl)oxy]-2-(sulphooxy)propyl]-3,4-dihydroisoquinolinium, inner salt, prepared as described in WO05/047264 (see, for example, page 18, Example 8), and 2-[3-[(2-butyloctyl)oxy]-2-(sulphooxy)propyl]-3,4-dihydroisoquinolinium, inner salt.

Suitable modified amine oxygen transfer catalysts include, but are not limited to, 1,2,3,4-tetrahydro-2-methyl-1-isoquinolinol, which can be made according to the procedures described in Tetrahedron Letters (1987), 28(48), 6061-6064. Suitable modified amine oxide oxygen transfer catalysts include, but are not limited to, sodium 1-hydroxy-N-oxy-N-[2-(sulphooxy)decyl]-1,2,3,4-tetrahydroisoquinoline.

Suitable N-sulphonyl imine oxygen transfer catalysts include, but are not limited to, 3-methyl-1,2-benzisothiazole 1,1-dioxide, prepared according to the procedure described in the Journal of Organic Chemistry (1990), 55(4), 1254-61.

Suitable N-phosphonyl imine oxygen transfer catalysts include, but are not limited to, [R-(E)]-N-[(2-chloro-5-nitrophenyl)methylene]-P-phenyl-P-(2,4,6-trimethylphenyl)-phosphinic amide, which can be made according to the procedures described in the Journal of the Chemical Society, Chemical Communications (1994), (22), 2569-70.

Suitable N-acyl imine oxygen transfer catalysts include, but are not limited to, [N(E)]-N-(phenylmethylene)acetamide, which can be made according to the procedures described in Polish Journal of Chemistry (2003), 77(5), 577-590.

Suitable thiadiazole dioxide oxygen transfer catalysts include but are not limited to, 3-methyl-4-phenyl-1,2,5-thiadiazole 1,1-dioxide, which can be made according to the procedures described in U.S. Pat. No. 5,753,599 (Column 9, Example 2).

Suitable perfluoroimine oxygen transfer catalysts include, but are not limited to, (Z)-2,2,3,3,4,4,4-heptafluoro-N-(nonafluorobutyl)butanimidoyl fluoride, which can be made according to the procedures described in Tetrahedron Letters (1994), 35(34), 6329-30.

Suitable cyclic sugar ketone oxygen transfer catalysts include, but are not limited to, 1,2:4,5-di-O-isopropylidene-D-erythro-2,3-hexodiuro-2,6-pyranose as prepared in U.S. Pat. No. 6,649,085 (Column 12, Example 1).

Preferably, the bleach catalyst comprises an iminium and/or carbonyl functional group and is typically capable of forming an oxaziridinium and/or dioxirane functional group upon acceptance of an oxygen atom, especially upon acceptance of an oxygen atom from a peroxyacid and/or salt thereof. Preferably, the bleach catalyst comprises an oxaziridinium functional group and/or is capable of forming an oxaziridinium functional group upon acceptance of an oxygen atom, especially upon acceptance of an oxygen atom from a peroxyacid and/or salt thereof. Preferably, the bleach catalyst comprises a cyclic iminium functional group, preferably wherein the cyclic moiety has a ring size of from five to eight atoms (including the nitrogen atom), preferably six atoms. Preferably, the bleach catalyst comprises an aryliminium functional group, preferably a bi-cyclic aryliminium functional group, preferably a 3,4-dihydroisoquinolinium functional group. Typically, the imine functional group is a quaternary imine functional group and is typically capable of forming a quaternary oxaziridinium functional group upon acceptance of an oxygen atom, especially upon acceptance of an oxygen atom from a peroxyacid and/or salt thereof.

Preferably, the bleach catalyst has a chemical structure corresponding to the following chemical formula

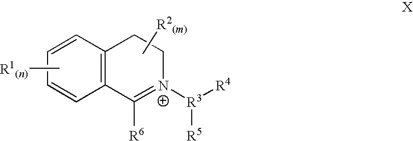

wherein: n and m are independently from 0 to 4, preferably n and m are both 0; each R¹ is independently selected from a substituted or unsubstituted radical selected from the group consisting of hydrogen, alkyl, cycloalkyl, aryl, fused aryl, heterocyclic ring, fused heterocyclic ring, nitro, halo, cyano, sulphonato, alkoxy, keto, carboxylic, and carboalkoxy radicals; and any two vicinal R¹ substituents may combine to form a fused aryl, fused carbocyclic or fused heterocyclic ring; each R² is independently selected from a substituted or unsubstituted radical independently selected from the group consisting of hydrogen, hydroxy, alkyl, cycloalkyl, alkaryl, aryl, aralkyl, alkylenes, heterocyclic ring, alkoxys, arylcarbonyl groups, carboxyalkyl groups and amide groups; any R² may be joined together with any other of R² to form part of a common ring; any geminal R² may combine to form a carbonyl; and any two R² may combine to form a substituted or unsubstituted fused unsaturated moiety; R² is a C₁ to C₂₀ substituted or unsubstituted alkyl; R⁴ is hydrogen or the moiety Qₜ-A, wherein: Q is a branched or unbranched alkylene, t=0 or 1 and A is an anionic group selected from the group consisting of OSO₃⁻, SO₃⁻, CO₂⁻, OCO₂⁻, OPO₃²⁻, OPO₃H⁻ and OPO₂⁻; R⁵ is hydrogen or the moiety —CR¹¹R¹²—Y-G_{b}-Y_{c}-[(CR⁹R¹⁰)_{y}—O]ₖ—R⁸, wherein: each Y is independently selected from the group consisting of O, S, N—H, or N—R⁸; and each R⁸ is independently selected from the group consisting of alkyl, aryl and heteroaryl, said moieties being substituted or unsubstituted, and whether substituted or unsubsituted said moieties having less than 21 carbons; each G is independently selected from the group consisting of CO, SO₂, SO, PO and PO₂; R⁹ and R¹⁰ are independently selected from the group consisting of H and C₁-C₄ alkyl; R¹¹ and R¹² are independently selected from the group consisting of H and alkyl, or when taken together may join to form a carbonyl; b=0 or 1; c can=0 or 1, but c must=0 if b=0; y is an integer from 1 to 6; k is an integer from 0 to 20; R⁶ is H, or an alkyl, aryl or heteroaryl moiety; said moieties being substituted or unsubstituted; and X, if present, is a suitable charge balancing counterion, preferably X is present when R⁴ is hydrogen, suitable X, include but are not limited to: chloride, bromide, sulphate, methosulphate, sulphonate, p-toluenesulphonate, borontetraflouride and phosphate.

In one embodiment of the present invention, the bleach catalyst has a structure corresponding to general formula below:

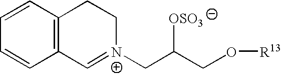

wherein R¹³ is a branched alkyl group containing from three to 24 carbon atoms (including the branching carbon atoms) or a linear alkyl group containing from one to 24 carbon atoms; preferably R¹³ is a branched alkyl group containing from eight to 18 carbon atoms or linear alkyl group containing from eight to eighteen carbon atoms; preferably R¹³ is selected from the group consisting of 2-propylheptyl, 2-butyloctyl, 2-pentylnonyl, 2-hexyldecyl, n-dodecyl, n-tetradecyl, n-hexadecyl, n-octadecyl, iso-nonyl, iso-decyl, iso-tridecyl and iso-pentadecyl; preferably R¹³ is selected from the group consisting of 2-butyloctyl, 2-pentylnonyl, 2-hexyldecyl, iso-tridecyl and iso-pentadecyl.

Glycosyl hydrolase—the glycosyl hydrolase typically has enzymatic activity towards both xyloglucan and amorphous cellulose substrates. Preferably, the glycosyl hydrolase is selected from GH families 5, 12, 44 or 74.

The enzymatic activity towards xyloglucan substrates is described in more detail below. The enzymatic activity towards amorphous cellulose substrates is described in more detail below.

The glycosyl hydrolase enzyme preferably belongs to glycosyl hydrolase family 44. The glycosyl hydrolase (GH) family definition is described in more detail in Biochem J. 1991, v280, 309-316.

The glycosyl hydrolase enzyme preferably has a sequence at least 70%, or at least 75% or at least 80%, or at least 85%, or at least 90%, or at least 95% identical to sequence ID No. 1.

For purposes of the present invention, the degree of identity between two amino acid sequences is determined using the Needleman-Wunsch algorithm (Needleman and Wunsch, 1970, J. Mol. Biol. 48: 443-453) as implemented in the Needle program of the EMBOSS package (EMBOSS: The European Molecular Biology Open Software Suite, Rice et al., 2000, Trends in Genetics 16: 276-277), preferably version 3.0.0 or later. The optional parameters used are gap open penalty of 10, gap extension penalty of 0.5, and the EBLOSUM62 (EMBOSS version of BLOSUM62) substitution matrix. The output of Needle labeled “longest identity” (obtained using the -nobrief option) is used as the percent identity and is calculated as follows: (Identical Residues x 100)/(Length of Alignment-Total Number of Gaps in Alignment).

Suitable glycosyl hydrolases are selected from the group consisting of: GH family 44 glycosyl hydrolases from Paenibacillus polyxyma (wild-type) such as XYG1006 described in WO 01/062903 or are variants thereof; GH family 12 glycosyl hydrolases from Bacillus licheniformis (wild-type) such as Seq. No. ID: 1 described in WO 99/02663 or are variants thereof; GH family 5 glycosyl hydrolases from Bacillus agaradhaerens (wild type) or variants thereof; GH family 5 glycosyl hydrolases from Paenibacillus (wild type) such as XYG1034 and XYG 1022 described in WO 01/064853 or variants thereof; GH family 74 glycosyl hydrolases from Jonesia sp. (wild type) such as XYG1020 described in WO 2002/077242 or variants thereof; and GH family 74 glycosyl hydrolases from Trichoderma Reesei (wild type), such as the enzyme described in more detail in Sequence ID no. 2 of WO03/089598, or variants thereof.

Preferred glycosyl hydrolases are selected from the group consisting of: GH family 44 glycosyl hydrolases from Paenibacillus polyxyma (wild-type) such as XYG1006 or are variants thereof.

Glycosyl Hydrolase Activity Towards Xyloglucan Substrates

An enzyme is deemed to have activity towards xyloglucan if the pure enzyme has a specific activity of greater than 50000 XyloU/g according to the following assay at pH 7.5.

The xyloglucanase activity is measured using AZCL-xyloglucan from Megazyme, Ireland as substrate (blue substrate).

A solution of 0.2% of the blue substrate is suspended in a 0.1M phosphate buffer pH 7.5, 20° C. under stirring in a 1.5 ml Eppendorf tubes (0.75 ml to each), 50 microlitres enzyme solution is added and they are incubated in an Eppendorf Thermomixer for 20 minutes at 40° C., with a mixing of 1200 rpm. After incubation the coloured solution is separated from the solid by 4 minutes centrifugation at 14,000 rpm and the absorbance of the supernatant is measured at 600 nm in a 1 cm cuvette using a spectrophotometer. One XyloU unit is defined as the amount of enzyme resulting in an absorbance of 0.24 in a 1 cm cuvette at 600 nm.

Only absorbance values between 0.1 and 0.8 are used to calculate the XyloU activity. If an absorbance value is measured outside this range, optimization of the starting enzyme concentration should be carried out accordingly.

Glycosyl Hydrolase Activity Towards Amorphous Cellulose Substrates

An enzyme is deemed to have activity towards amorphous cellulose if the pure enzyme has a specific activity of greater than 20000 EBG/g according to the following assay at pH 7.5. Chemicals used as buffers and substrates were commercial products of at least reagent grade.

Endoglucanase Activity Assay Materials:

0.1M phosphate buffer pH 7.5

Cellazyme C tablets, supplied by Megazyme International, Ireland.

Glass microfiber filters, GF/C, 9 cm diameter, supplied by Whatman.

Method:

In test tubes, mix 1 ml pH 7,5 buffer and 5 ml deionised water.

Add 100 microliter of the enzyme sample (or of dilutions of the enzyme sample with known weight:weight dilution factor). Add 1 Cellazyme C tablet into each tube, cap the tubes and mix on a vortex mixer for 10 seconds. Place the tubes in a thermostated water bath, temperature 40° C. After 15, 30 and 45 minutes, mix the contents of the tubes by inverting the tubes, and replace in the water bath. After 60 minutes, mix the contents of the tubes by inversion and then filter through a GF/C filter. Collect the filtrate in a clean tube.

Measure Absorbance (Aenz) at 590 nm, with a spectrophotometer. A blank value, A water, is determined by adding 100 μl water instead of 100 microliter enzyme dilution.

Calculate Adelta=Aenz−Awater.

Adelta must be <0.5. If higher results are obtained, repeat with a different enzyme dilution factor.

Determine DFO.1, where DFO.1 is the dilution factor needed to give Adelta=0.1.

Unit Definition: 1 Endo-Beta-Glucanase activity unit (1 EBG) is the amount of enzyme that gives Adelta=0.10, under the assay conditions specified above. Thus, for example, if a given enzyme sample, after dilution by a dilution factor of 100, gives Adelta=0.10, then the enzyme sample has an activity of 100 EBG/g.

Amphiphilic alkoxylated grease cleaning polymer—Amphiphilic alkoxylated grease cleaning polymers of the present invention refer to any alkoxylated polymers having balanced hydrophilic and hydrophobic properties such that they remove grease particles from fabrics and surfaces. Specific embodiments of the amphiphilic alkoxylated grease cleaning polymers of the present invention comprise a core structure and a plurality of alkoxylate groups attached to that core structure.

The core structure may comprise a polyalkylenimine structure comprising, in condensed form, repeating units of formulae (I), (II), (III) and (IV):

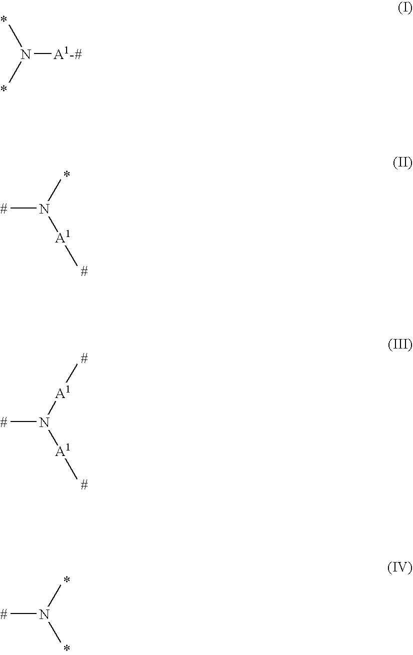

wherein # in each case denotes one-half of a bond between a nitrogen atom and the free binding position of a group A¹ of two adjacent repeating units of formulae (I), (II), (III) or (IV); * in each case denotes one-half of a bond to one of the alkoxylate groups; and A¹ is independently selected from linear or branched C₂-C₆-alkylene; wherein the polyalkylenimine structure consists of 1 repeating unit of formula (I), x repeating units of formula (II), y repeating units of formula (III) and y+1 repeating units of formula (IV), wherein x and y in each case have a value in the range of from 0 to about 150; where the average weight average molecular weight, Mw, of the polyalkylenimine core structure is a value in the range of from about 60 to about 10,000 g/mol.

The core structure may alternatively comprise a polyalkanolamine structure of the condensation products of at least one compound selected from N-(hydroxyalkyl)amines of formulae (I.a) and/or (I.b),

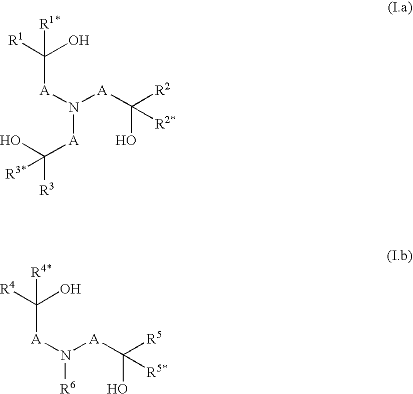

wherein A are independently selected from C₁-C₆-alkylene; R¹, R¹*, R², R²*, R³, R³*, R⁴, R⁴*, R⁵ and R⁵* are independently selected from hydrogen, alkyl, cycloalkyl or aryl, wherein the last three mentioned radicals may be optionally substituted; and R⁶ is selected from hydrogen, alkyl, cycloalkyl or aryl, wherein the last three mentioned radicals may be optionally substituted.

The plurality of alkylenoxy groups attached to the core structure are independently selected from alkylenoxy units of the formula (V)

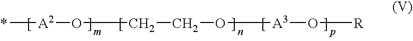

wherein * in each case denotes one-half of a bond to the nitrogen atom of the repeating unit of formula (I), (II) or (IV); A² is in each case independently selected from 1,2-propylene, 1,2-butylene and 1,2-isobutylene; A³ is 1,2-propylene; R is in each case independently selected from hydrogen and C₁-C₄-alkyl; m has an average value in the range of from 0 to about 2; n has an average value in the range of from about 20 to about 50; and p has an average value in the range of from about 10 to about 50.

Specific embodiments of the amphiphilic alkoxylated grease cleaning polymers may be selected from alkoxylated polyalkylenimines having an inner polyethylene oxide block and an outer polypropylene oxide block, the degree of ethoxylation and the degree of propoxylation not going above or below specific limiting values. Specific embodiments of the alkoxylated polyalkylenimines according to the present invention have a minimum ratio of polyethylene blocks to polypropylene blocks (n/p) of about 0.6 and a maximum of about 1.5(x+2y+1)^{1/2}. Alkoxykated polyalkyenimines having an n/p ratio of from about 0.8 to about 1.2(x+2y+1)^{1/2} have been found to have especially beneficial properties.

The alkoxylated polyalkylenimines according to the present invention have a backbone which consists of primary, secondary and tertiary amine nitrogen atoms which are attached to one another by alkylene radicals A and are randomly arranged. Primary amino moieties which start or terminate the main chain and the side chains of the polyalkylenimine backbone and whose remaining hydrogen atoms are subsequently replaced by alkylenoxy units are referred to as repeating units of formulae (I) or (IV), respectively. Secondary amino moieties whose remaining hydrogen atom is subsequently replaced by alkylenoxy units are referred to as repeating units of formula (II). Tertiary amino moieties which branch the main chain and the side chains are referred to as repeating units of formula (III).

Since cyclization can occur in the formation of the polyalkylenimine backbone, it is also possible for cyclic amino moieties to be present to a small extent in the backbone. Such polyalkylenimines containing cyclic amino moieties are of course alkoxylated in the same way as those consisting of the noncyclic primary and secondary amino moieties.

The polyalkylenimine backbone consisting of the nitrogen atoms and the groups A¹, has an average molecular weight Mw of from about 60 to about 10,000 g/mole, preferably from about 100 to about 8,000 g/mole and more preferably from about 500 to about 6,000 g/mole.

The sum (x+2y+1) corresponds to the total number of alkylenimine units present in one individual polyalkylenimine backbone and thus is directly related to the molecular weight of the polyalkylenimine backbone. The values given in the specification however relate to the number average of all polyalkylenimines present in the mixture. The sum (x+2y+2) corresponds to the total number amino groups present in one individual polyalkylenimine backbone.

The radicals A¹ connecting the amino nitrogen atoms may be identical or different, linear or branched C₂-C₆-alkylene radicals, such as 1,2-ethylene, 1,2-propylene, 1,2-butylene, 1,2-isobutylene,1,2-pentanediyl, 1,2-hexanediyl or hexamethylen. A preferred branched alkylene is 1,2-propylene. Preferred linear alkylene are ethylene and hexamethylene. A more preferred alkylene is 1,2-ethylene.

The hydrogen atoms of the primary and secondary amino groups of the polyalkylenimine backbone are replaced by alkylenoxy units of the formula (V).

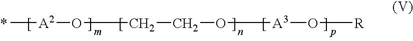

In this formula, the variables preferably have one of the meanings given below:

A² in each case is selected from 1,2-propylene, 1,2-butylene and 1,2-isobutylene; preferably A² is 1,2-propylene. A³ is 1,2-propylene; R in each case is selected from hydrogen and C₁-C₄-alkyl, such as methyl, ethyl, n-propyl, isopropyl, n-butyl, isobutyl and tert.-butyl; preferably R is hydrogen. The index m in each case has a value of 0 to about 2; preferably m is 0 or approximately 1; more preferably m is 0. The index n has an average value in the range of from about 20 to about 50, preferably in the range of from about 22 to about 40, and more preferably in the range of from about 24 to about 30. The index p has an average value in the range of from about 10 to about 50, preferably in the range of from about 11 to about 40, and more preferably in the range of from about 12 to about 30.

Preferably the alkylenoxy unit of formula (V) is a non-random sequence of alkoxylate blocks. By non-random sequence it is meant that the [-A²O—]ₘ is added first (i.e., closest to the bond to the nitrgen atom of the repeating unit of formula (I), (II), or (III)), the [—CH₂—CH₂—O—]ₙ is added second, and the [-A³-O—]ₚ is added third. This orientation provides the alkoxylated polyalkylenimine with an inner polyethylene oxide block and an outer polypropylene oxide block.

The substantial part of these alkylenoxy units of formula (V) is formed by the ethylenoxy units —[CH₂—CH₂—O)]ₙ— and the propylenoxy units —[CH₂—CH₂(CH₃)—O]ₚ—. The alkylenoxy units may additionally also have a small proportion of propylenoxy or butylenoxy units —[A²—O]ₘ—, i.e. the polyalkylenimine backbone saturated with hydrogen atoms may be reacted initially with small amounts of up to about 2 mol, especially from about 0.5 to about 1.5 mol, in particular from about 0.8 to about 1.2 mol, of propylene oxide or butylene oxide per mole of NH— moieties present, i.e. incipiently alkoxylated.

This initial modification of the polyalkylenimine backbone allows, if necessary, the viscosity of the reaction mixture in the alkoxylation to be lowered. However, the modification generally does not influence the performance properties of the alkoxylated polyalkylenimine and therefore does not constitute a preferred measure.

The amphiphilic alkoxylated grease cleaning polymers are present in the detergent and cleaning compositions of the present invention at levels ranging from about 0.05% to 10% by weight of the composition. Embodiments of the compositions may comprise from about 0.1% to about 5% by weight. More specifically, the embodiments may comprise from about 0.25 to about 2.5% of the grease cleaning polymer.

Random graft co-polymer—The random graft co-polymer comprises: (i) hydrophilic backbone comprising monomers selected from the group consisting of: unsaturated C₁-C₆ carboxylic acids, ethers, alcohols, aldehydes, ketones, esters, sugar units, alkoxy units, maleic anhydride, saturated polyalcohols such as glycerol, and mixtures thereof; and (ii) hydrophobic side chain(s) selected from the group consisting of: C₄-C₂₅ alkyl group, polypropylene, polybutylene, vinyl ester of a saturated C₁-C₆ mono-carboxylic acid, C₁-C₆ alkyl ester of acrylic or methacrylic acid, and mixtures thereof.

The polymer preferably has the general formula:

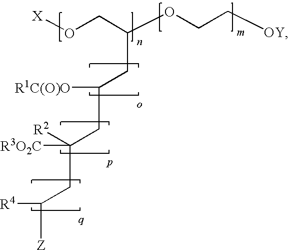

wherein X, Y and Z are capping units independently selected from H or a C₁₋₆ alkyl; each R¹ is independently selected from methyl and ethyl; each R² is independently selected from H and methyl; each R³ is independently a C₁₋₄ alkyl; and each R⁴ is independently selected from pyrrolidone and phenyl groups. The weight average molecular weight of the polyethylene oxide backbone is typically from about 1,000 g/mol to about 18,000 g/mol, or from about 3,000 g/mol to about 13,500 g/mol, or from about 4,000 g/mol to about 9,000 g/mol. The value of m, n, o, p and q is selected such that the pendant groups comprise, by weight of the polymer at least 50%, or from about 50% to about 98%, or from about 55% to about 95%, or from about 60% to about 90%. The polymer useful herein typically has a weight average molecular weight of from about 1,000 to about 100,000 g/mol, or preferably from about 2,500 g/mol to about 45,000 g/mol, or from about 7,500 g/mol to about 33,800 g/mol, or from about 10,000 g/mol to about 22,500 g/mol.

Suitable graft co-polymers are described in more detail in WO07/138054, WO06/108856 and WO06/113314.

Reserve Alkalinity—The composition may have a reserve alkalinity of greater than 4.0, preferably greater than 7.5. As used herein, the term “reserve alkalinity” is a measure of the buffering capacity of the detergent composition (g/NaOH/100 g detergent composition) determined by titrating a 1% (w/v) solution of detergent composition with hydrochloric acid to pH 7.5 i.e. in order to calculate Reserve Alkalinity as defined herein:

Reserve Alkalinity (to pH 7.5) as % alkali in g NaOH/100 g product=(T×M×40×Vol)/(10×Wt×Aliquot)

T=titre (ml) to pH 7.5

M=Molarity of HCl=0.2

40=Molecular weight of NaOH

Vol=Total volume (i.e. 1000 ml)

W=Weight of product (10 g)

Aliquot=(100 ml)

Obtain a 10 g sample accurately weighed to two decimal places, of fully formulated detergent composition. The sample should be obtained using a Pascall sampler in a dust cabinet. Add the 10 g sample to a plastic beaker and add 200 ml of carbon dioxide-free deionised water. Agitate using a magnetic stirrer on a stirring plate at 150 rpm until fully dissolved and for at least 15 minutes. Transfer the contents of the beaker to a 1 litre volumetric flask and make up to 1 litre with deionised water. Mix well and take a 100 mls*1 ml aliquot using a 100 mls pipette immediately. Measure and record the pH and temperature of the sample using a pH meter capable of reading to ±0.1 pH units, with stirring, ensuring temperature is 21° C.±2° C. Titrate whilst stirring with 0.2M hydrochloric acid until pH measures exactly 7.5. Note the millilitres of hydrochloric acid used. Take the average titre of three identical repeats. Carry out the calculation described above to calculate RA to pH 7.5.

The RA of the detergent compositions of the invention will be greater than 7.5 and preferably greater than 8. The RA may be greater than 9 or even greater than 9.5 or 10 or higher. The RA may be up to 20 or higher.

Adequate reserve alkalinity may be provided, for example, by one or more of alkali metal silicates (excluding crystalline layered silicate), typically amorphous silicate salts, generally 1.2 to 2.2 ratio sodium salts, alkali metal typically sodium carbonate, bicarbonate and/or sesquicarbonates. STPP and persalts such as perborates and percarbonates also contribute to alkalinity. Buffering is necessary to maintain an alkaline pH during the wash process counteracting the acidity of soils, especially fatty acids liberated by the lipase enzyme.

Perfume—The composition may comprise perfume. The perfume may be encapsulated, for example by starch. The perfume may be encapsulated by a urea-formaldehyde or melamine-formaldehyde material. Such perfume encapsulates may be in the form of a perfume microcapsule.

The composition may comprise an encapsulated perfume and an unencapsulated perfume, wherein the weight ratio of perfume raw materials having the general structure: R¹R²R³CC(O)OR⁴, wherein R¹ R² R³ are each independently selected from H, alkyl, aryl, alkylaryl, cyclic alkyl, and wherein either at least one, preferably at least two, of R¹ R² R³ are H, present in the encapsulated perfume to those perfume raw materials also having the above general structure present in the unencapsulated perfume is greater than 3:1, preferably greater than 4:1, or even greater than 5:1, or 10:1, or 15:1 or even 20:1.

Typical perfume raw materials having the above general structure include: benzyl acetate, hexyl acetate, allyl caproate, geranyl butyrate, geranyl acetate, ethyl butyrate, neryl butyrate, citronellyl acetate, ethyl-2-methyl pentanoate, isopropyl 2-methyl butyrate and allyl amyl glycolate. Other perfume raw materials having the above general structure include: manzanate™ supplied by Quest, Ashford, Kent, UK; and vertenex™, verdox™, violiff™ supplied by International Flavors and Fragrances, N.J., USA.

The composition may comprises a perfume, wherein the perfume comprising at least 10 wt % of one or more perfume raw materials having a molecular weight of greater than 0 but less than or equal to 350 daltons, at least 80 wt % of said one or more perfume raw materials having a cLogP of at least 2.4, said perfume composition comprising at least 5 wt % of said one or more perfume components having a cLogP of at least 2.4.

The perfume compositions disclosed herein are especially useful for masking odors, particularly fatty acid odors, more particularly short-chain fatty acid odors such the odor of butyric acid, such perfume compositions are especially useful in detergent powders.

In one aspect of the invention said perfume comprises at least 10 % , 20%, 30%, 40% , 50%, 60%, 70%, 80%, or even 90% of one or more perfume raw materials having a molecular weight of greater than 0 but less than or equal to 350 daltons, from about 100 daltons to about 350 daltons, from about 130 daltons to about 270 daltons, or even from about 140 daltons to about 230 daltons; at least 80 wt %, 85 wt %, 90 wt % or even 95 wt % of said one or more perfume raw materials having a cLogP of at least 2.4, from about 2.75 to about 8.0 or even from about 2.9 to about 6.0, said perfume comprising at least 5 wt %, 15 wt %, 25 wt %, 35 wt %, 45 wt %, 55 wt %, 65 wt %, 75 wt %, 85 wt %, or even 95 wt % of said one or more perfume components having a cLogP in the range of at least 2.4, from about 2.75 to about 8.0 or even from about 2.9 to about 6.0. In said aspect of the invention said one or more perfume components may be selected from the group consisting of a Schiff's base, ether, phenol, ketone, alcohol, ester, lactone, aldehyde, nitrile, natural oil or mixtures thereof.

Washing Method

The present invention includes a method for cleaning and/or treating a situs inter alia a surface or fabric. Such method includes the steps of contacting an embodiment of Applicants' cleaning composition, in neat form or diluted in a wash liquor, with at least a portion of a surface or fabric then optionally rinsing such surface or fabric. The surface or fabric may be subjected to a washing step prior to the aforementioned rinsing step. For purposes of the present invention, washing includes but is not limited to, scrubbing, and mechanical agitation. As will be appreciated by one skilled in the art, the cleaning compositions of the present invention are ideally suited for use in laundry applications. Accordingly, the present invention includes a method for laundering a fabric. The method comprises the steps of contacting a fabric to be laundered with a said cleaning laundry solution comprising at least one embodiment of Applicants' cleaning composition, cleaning additive or mixture thereof. The fabric may comprise most any fabric capable of being laundered in normal consumer use conditions. The solution preferably has a pH of from about 8 to about 10.5. The compositions may be employed at concentrations of from about 100 ppm, preferably 500ppm to about 15,000 ppm in solution. The water temperatures typically range from about 5° C. to about 90° C. The invention may be particularly beneficial at low water temperatures such as below 30° C. or below 25 or 20° C. The water to fabric ratio is typically from about 1:1 to about 30:1.

### EXAMPLES

The present invention is further described by the following examples which should not be construed as limiting the scope of the invention.

Chemicals used as buffers and substrates were commercial products of at least reagent grade.

### Example 1

### Expression of Lipase Variants

A plasmid containing the gene encoding the lipolytic enzyme variant is constructed and transformed into a suitable host cell using standard methods of the art.

### Example 2

### Production of Lipase Variants

Fermentation is carried out as a fed-batch fermentation using a constant medium temperature of 34° C. and a start volume of 1.2 liter. The initial pH of the medium is set to 6.5. Once the pH has increased to 7.0 this value is maintained through addition of 10% H₃PO₄. The level of dissolved oxygen in the medium is controlled by varying the agitation rate and using a fixed aeration rate of 1.0 liter air per liter medium per minute. The feed addition rate is maintained at a constant level during the entire fed-batch phase.

The batch medium contains maltose syrup as carbon source, urea and yeast extract as nitrogen source and a mixture of trace metals and salts. The feed added continuously during the fed-batch phase contains maltose syrup as carbon source whereas yeast extract and urea is added in order to assure a sufficient supply of nitrogen.

Purification of the lipolytic enzyme variant may be done by use of standard methods known in the art, e.g. by filtering the fermentation supernatant and subsequent hydrophobic chromatography and ion exchange chromatography, e.g. as described in EP 0 851 913 EP, Example 3.

### Example 3

### In-Detergent Stability of Lipolytic Enzyme Variants

The following lipolytic enzyme variants were tested for stability in detergent and compared to the reference lipolytic enzyme SEQ ID NO: 2.

TABLE 2
The tested lipolytic enzyme variants.

| | | Specific activity |
|---|---|---|
| Variant | Mutations in SEQ ID NO: 2 | LU/A280 |
| Ref | — | 4760 |
| 1 | T231R + N233R + P256K | 963 |
| 2 | L227G + T231R + N233R | 5000 |
| 3 | L227G + T231R + N233R + P256K | 2674 |
| 4 | D27R + T231R + N233R | 3199 |
| 5 | D27R + L227G + T231R + N233R | 5020 |
| 6 | S216P + T231R + N233R | 3323 |

The lipolytic enzyme variants and the reference were dosed to a concentration of 0.065 mg enzyme protein per gram commercial detergent.

TABLE 3
Composition of the detergent.

| INGREDIENT | Origin | % wt. |
|---|---|---|
| Sodium alkyl ether sulphate | Steol 25-2S.70, Stepan Deutschland | 12.0 |
| LAS | Surfac SDBS80, Surfachem | 7.0 |
| Soap Tallow/Coconut 80/20 | Linds Fabrikker | 3.2 |
| 23-9 Alcohol ethoxylate | Neodol 23-9, Shell Chemical | 2.4 |
| Alkyl dimethylamine oxide | Empigen OB, Huntsman | 2.0 |
| Citric acid (sodium) | Merck | 2.8 |
| Sodium hydroxide 10 N | Bie & Berntsen | 1.6 |
| Glycerine | Optim Glycerine 99.7% USP/EP, | 2.3 |
| | Dow Chemical | |
| Monoethanolamine | Huntsman | 2.7 |
| MPG | Proylene Glycol Industrial, Dow | 4.7 |
| | Chemical | |
| Water | | 59.3 |

Samples comprising detergent and lipolytic enzyme variants or a reference enzyme were dissolved in tris(hydroxymethyl)aminomethan (TRIS) buffer at pH=7.7 and stored at −18° C. and 35° C. for 2 and 4 weeks respectively. The residual enzymatic activity was calculated as the lipase activity after incubation at 35° C. divided by the lipase activity of the samples stored at −18° C. The stability data are shown in Table 4 below. All six lipolytic enzyme variants demonstrated improved in-detergent stability, compared to the reference lipase.

The lipase activity was measured by monitoring the hydrolysis of the substrate p-Nitrophenyl-Valerate (pNp-Val) to generate the products valerate and pNp. Detection wavelength=405 nm; pH=7.7; and temperature=37° C. All lipases having esterase activity at this pH can be analyzed with this method.

TABLE 4
Residual lipolytic activity after storage. Data shown as an average of triplicates.

| Variant: | Ref. | 1 | 2 | 3 | 4 | 5 | 6 |
|---|---|---|---|---|---|---|---|
| −18° C. | 0.238 | 0.272 | 0.255 | 0.266 | 0.238 | 0.248 | 0.175 |
| | 0.242 | 0.285 | 0.239 | 0.260 | 0.216 | 0.260 | 0.188 |
| | 0.237 | 0.299 | 0.236 | 0.273 | 0.216 | 0.256 | 0.184 |
| Average −18° C. | 0.239 | 0.285 | 0.243 | 0.267 | 0.223 | 0.255 | 0.182 |
| 2 weeks 35° C. | 0.191 | 0.254 | 0.193 | 0.215 | 0.190 | 0.236 | 0.173 |
| | 0.170 | 0.249 | 0.196 | 0.224 | 0.202 | 0.239 | 0.169 |
| | 0.170 | 0.250 | 0.194 | 0.233 | 0.200 | 0.239 | 0.167 |
| Average 2 w | 0.177 | 0.251 | 0.195 | 0.224 | 0.197 | 0.238 | 0.170 |
| 4 weeks 35° C. | 0.133 | 0.217 | 0.156 | 0.203 | 0.175 | 0.221 | 0.165 |
| | 0.135 | 0.211 | 0.155 | 0.204 | 0.176 | 0.218 | 0.158 |
| | 0.134 | 0.216 | 0.154 | 0.200 | 0.180 | 0.218 | 0.156 |
| Average 4 w | 0.134 | 0.215 | 0.155 | 0.203 | 0.177 | 0.219 | 0.160 |
| % Residual | 74 | 88 | 80 | 84 | 88 | 93 | 93 |
| activity 2 w | | | | | | | |
| % Residual | 56 | 75 | 64 | 76 | 79 | 86 | 88 |
| activity 4 w | | | | | | | |

### Detergent Examples

Abbreviated component identifications for the examples are as follows:
LAS Sodium linear C₁₁₋₁₃ alkyl benzene sulphonate.
CxyAS Sodium C₁ₓ-C_{1y} alkyl sulfate.
CxyEzS C₁ₓ-C_{1y} sodium alkyl sulfate condensed with an average of z moles of ethylene oxide.
CxyEy C₁ₓ-C_{1y} alcohol with an average of ethoxylation of z
QAS R₂.N+(CH₃)₂(C₂H₄OH) with R₂═C₁₀-C₁₂
Silicate Amorphous Sodium Silicate (SiO₂:Na₂O ratio=1.6-3.2:1).
Zeolite A Hydrated Sodium Aluminosilicate of formula Na₁₂(AlO₂SiO₂)₁₂. 27H₂O having a primary particle size in the range from 0.1 to 10 micrometers (Weight expressed on an anhydrous basis).
(Na—)SKS-6 Crystalline layered silicate of formula δ-Na₂Si₂O₅.
Citrate Tri-sodium citrate dihydrate.
Citric Anhydrous citric acid.
Carbonate Anhydrous sodium carbonate.
Sulphate Anhydrous sodium sulphate.
MA/AA Random copolymer of 4:1 acrylate/maleate, average molecular weight about 70,000-80,000.
AA polymer Sodium polyacrylate polymer of average molecular weight 4,500.
PB1/PB4 Anhydrous sodium perborate monohydrate/tetrahydrate.
PC3 Anhydrous sodium percarbonate [2.74 Na₂CO₃.3H₂O₂]
TAED Tetraacetyl ethylene diamine.
NOBS Nonanoyloxybenzene sulfonate in the form of the sodium salt.
DTPA Diethylene triamine pentaacetic acid.
HEDP Hydroxyethane di phosphonate
EDDS Na salt of Ethylenediamine-N,N′-disuccinic acid, (S,S) isomer
STPP Sodium tripolyphosphate
Protease Proteolytic enzyme sold under the tradename Savinase®, Alcalase®, Everlase®, Coronase®, Polarzyme®, by Novozymes A/S, Properase®, Purafect®, Purafect MA® and Purafect Ox® sold by Genencor and proteases described in patents WO 91/06637 and/or WO 95/10591 and/or EP 0 251 446 such as FNA, FN3 and/or FN4.
Amylase Amylolytic enzyme sold under the tradename Purastar®, Purafect Oxam® sold by Genencor; Termamyl®, Fungamyl® Duramyl®, Stainzyme® and Natalase® sold by Novozymes A/S.
Lipase Any lipase variant 1 to 5 described in example 3 table 2, and combinations thereof.
Mannanase Mannaway® sold by Novozymes
CMC or HEC Carboxymethyl or Hydroxyethyl or ester modified cellulose. or EMC
SS Agglom. Suds Suppressor agglomerate: 12% Silicone/silica, 18% stearyl alcohol, 70% starch in granular form.
TEPAE Tetreaethylenepentaamine ethoxylate.
pH Measured as a 1% solution in distilled water at 20° C.

### Example A

Bleaching detergent compositions having the form of granular laundry detergents are exemplified by the following formulations.

| | A | B | C | D | E | F |
|---|---|---|---|---|---|---|
| LAS | 12 | 15 | 13 | 15 | 10 | 14 |
| QAS | 0.7 | 1 | 1 | 0.6 | 0.0 | 0.7 |
| C25E3S | 0.9 | 0.0 | 0.9 | 0.0 | 0.0 | 0.9 |
| C25E7 | 0.0 | 0.5 | 0.0 | 1 | 3 | 1 |
| STPP | 5 | 3 | 1 | 10 | 0 | 8 |
| Zeolite A | 0.0 | 0.0 | 0.0 | 0.0 | 10 | 0.0 |
| Silicate | 2 | 3 | 3 | 7 | 0 | 4 |
| Carbonate | 15 | 14 | 15 | 18 | 15 | 15 |
| AA Polymer | 1 | 0.0 | 1 | 1 | 1.5 | 1 |
| CMC | 1 | 1 | 1 | 1 | 1 | 1 |
| Protease 32.89 mg/g | 0.1 | 0.07 | 0.1 | 0.1 | 0.1 | 0.1 |
| Amylase 8.65 mg/g | 0.1 | 0.1 | 0.1 | 0.0 | 0.1 | 0.1 |
| Lipase 18 mg/g | 0.03 | 0.07 | 0.3 | 0.1 | 0.07 | 0.1 |
| Brightener - Tinopal AMS (Ciba) | 0.06 | 0.0 | 0.06 | 0.18 | 0.06 | 0.06 |
| Brightener - Tinopal CBS-X | 0.1 | 0.06 | 0.1 | 0.0 | 0.1 | 0.1 |
| (Ciba) | | | | | | |
| DTPA | 0.6 | 0.3 | 0.6 | 0.25 | 0.6 | 0.6 |
| MgSO₄ | 1 | 1 | 1 | 0.5 | 1 | 1 |
| PC3 | 0.0 | 5.2 | 0.1 | 0.0 | 0.0 | 0.0 |
| PB1 | 4.4 | 0.0 | 3.85 | 2.09 | 0.78 | 3.63 |
| NOBS | 1.9 | 0.0 | 1.66 | 1.77 | 0.33 | 0.75 |
| TAED | 0.58 | 1.2 | 0.51 | 0.0 | 0.015 | 0.28 |
| Hueing agent | 0.005 | 0.01 | 0.001 | 0 | 0.003 | 0 |
| Perfume microcapsule | 0.2 | 0.5 | 0.1 | 0 | 0.3 | 0.3 |
| Unencapsulated perfume | 0.5 | 0.5 | 0.5 | 0.5 | 0.5 | 0.5 |
| Random graft copolymer | 0.5 | 1.1 | 0.8 | 0.9 | 0.7 | 0 |
| Sulphate/Moisture/Misc | Balance | Balance to | Balance | Balance | Balance | Balance |
| | to 100% | 100% | to 100% | to 100% | to 100% | to 100% |

Any of the compositions in Example A is used to launder fabrics at a concentration of 600-10000 ppm in water, with typical median conditions of 2500 ppm, 25° C., and a 25:1 water:cloth ratio.

### Example B

Bleaching detergent compositions having the form of granular laundry detergents are exemplified by the following formulations.

| | A | B | C | D |
|---|---|---|---|---|
| LAS | 8 | 7.1 | 7 | 6.5 |
| C25E3S | 0 | 4.8 | 0 | 5.2 |
| C68S | 1 | 0 | 1 | 0 |
| C25E7 | 2.2 | 0 | 3.2 | 0 |
| QAS | 0.75 | 0.94 | 0.98 | 0.98 |
| (Na-)SKS-6 | 4.1 | 0 | 4.8 | 0 |
| Zeolite A | 20 | 0 | 17 | 0 |
| Citric | 3 | 5 | 3 | 4 |
| Carbonate | 15 | 20 | 14 | 20 |
| Silicate | 0.08 | 0 | 0.11 | 0 |
| Soil release agent | 0.75 | 0.72 | 0.71 | 0.72 |
| MA/AA | 1.1 | 3.7 | 1.0 | 3.7 |
| CMC | 0.15 | 1.4 | 0.2 | 1.4 |
| Protease (56.00 mg active/g) | 0.37 | 0.4 | 0.4 | 0.4 |
| Termamyl (21.55 mg active/g) | 0.3 | 0.3 | 0.3 | 0.3 |
| Lipase (18.00 mg active/g) | 0.05 | 0.15 | 0.1 | 0.5 |
| Amylase (8.65 mg active/g) | 0.1 | 0.14 | 0.14 | 0.3 |
| TAED | 3.6 | 4.0 | 3.6 | 4.0 |
| PC3 | 13 | 13.2 | 13 | 13.2 |
| EDDS | 0.2 | 0.2 | 0.2 | 0.2 |
| HEDP | 0.2 | 0.2 | 0.2 | 0.2 |
| MgSO₄ | 0.42 | 0.42 | 0.42 | 0.42 |
| Perfume | 0.5 | 0.6 | 0.5 | 0.6 |
| SS Agglom. | 0.05 | 0.1 | 0.05 | 0.1 |
| Soap | 0.45 | 0.45 | 0.45 | 0.45 |
| Hueing agent | 0.005 | 0.01 | 0.001 | 0 |
| Perfume microcapsule | 0.2 | 0.5 | 0.1 | 0 |
| Unencapsulated perfume | 0.5 | 0.5 | 0.5 | 0.5 |
| Random graft copolymer | 0.5 | 1.1 | 0.8 | 0.9 |

| | |
|---|---|
| Sulphate, water & miscellaneous | Balance to 100% |

Any of the above compositions in Example B is used to launder fabrics at a concentration of 10,000 ppm in water, 20-90° C., and a 5:1 water:cloth ratio.

### Example C

| | | B | C | D | E | F |
|---|---|---|---|---|---|---|
| | A (wt %) | (wt %) | (wt %) | (wt %) | (wt %) | (wt %) |
| C25E1.8S | 11 | 10 | 4 | 6.32 | 15 | 19 |
| LAS | 4 | 5.1 | 8 | 3.3 | 5.0 | 6.0 |
| Sodium formate | 1.6 | 0.09 | 1.2 | 0.04 | 1.6 | 1.2 |
| Sodium hydroxide | 2.3 | 3.8 | 1.7 | 1.9 | 2.3 | 1.7 |
| Monoethanolamine | 1.4 | 1.490 | 1.0 | 0.7 | 1.35 | 1.0 |
| Diethylene glycol | 5.5 | 0.0 | 4.1 | 0.0 | 5.500 | 4.1 |
| C23E9 | 0.4 | 0.6 | 0.3 | 0.3 | 2 | 0.3 |
| DTPA | 0.15 | 0.15 | 0.11 | 0.07 | 0.15 | 0.2 |
| Citric Acid | 2.5 | 3.96 | 1.88 | 1.98 | 2.5 | 1.88 |
| C₁₂₋₁₄ dimethyl | 0.3 | 0.73 | 0.23 | 0.37 | 0.3 | 0.225 |
| Amine Oxide | | | | | | |
| C₁₂₋₁₈ Fatty Acid | 0.8 | 1.9 | 0.6 | 0.99 | 0.8 | 0.6 |
| Borax | 1.43 | 1.5 | 1.1 | 0.75 | 1.43 | 1.07 |
| Ethanol | 1.54 | 1.77 | 1.15 | 0.89 | 1.54 | 1.15 |
| TEPAE¹ | 0.3 | 0.33 | 0.23 | 0.17 | 0.0 | 0.0 |
| ethoxylated hexamethylene | 0.8 | 0.81 | 0.6 | 0.4 | 0.0 | 0.0 |
| diamine² | | | | | | |
| 1,2-Propanediol | 0.0 | 6.6 | 0.0 | 3.3 | 0.0 | 0.0 |
| Protease* | 36.4 | 36.4 | 27.3 | 18.2 | 36.4 | 27.3 |
| Mannanase* | 1.1 | 1.1 | 0.8 | 0.6 | 1.1 | 0.8 |
| Amylase* | 7.3 | 7.3 | 5.5 | 3.7 | 7.3 | 5.5 |
| Lipase* | 10 | 3.2 | 0.5 | 3.2 | 2.4 | 3.2 |
| Amphiphilic | 0.3 | 0.5 | 0.7 | 0.5 | 0.3 | 0 |
| alkoxylated grease cleaning | | | | | | |
| polymer | | | | | | |
| Random graft co-polymer | 0.5 | 0.3 | 0.5 | 0.7 | 0.5 | 0 |
| Hueing agent | 0.001 | 0.003 | 0.005 | 0.01 | 0 | 0 |
| Unencapsulated | 0.5 | 0.5 | 0.5 | 0.5 | 0.5 | 0.5 |
| perfume | | | | | | |
| Perfume | 0.2 | 0.1 | 0.3 | 0.2 | 0.1 | 0 |
| microcapsule | | | | | | |
| Trihydroxystearin | 0.2 | 0.1 | 0.3 | 0.2 | 0.1 | 0 |
| Water, dyes & | Balance | Balance | Balance | Balance | Balance | Balance |
| others | | | | | | |

*Numbers quoted in mg enzyme/100 g
¹as described in U.S. Pat. No. 4,597,898.
²available under the tradename LUTENSIT ® from BASF and such as those described in WO 01/05874

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A detergent composition comprising a variant of a parent lipolytic enzyme, wherein the variant:
(a) has an amino acid sequence which compared to the parent lipolytic enzyme comprises substitution of an amino acid residue corresponding to any of amino acids 27, 216, 227, 231, 233 and 256 of SEQ ID NO: 2; and
(b) optionally, is more in-detergent stable than the parent lipolytic enzyme.

2. A detergent composition according to claim 1, wherein the variant of a parent lipolytic enzyme:
(a) comprises the amino acid residues 231 and 233, and has an amino acid sequence which compared to the parent lipolytic enzyme comprises substitution of at least one amino acid residue corresponding to any of amino acids 27, 216, 227 and 256 of SEQ ID NO: 2; and
(b) optionally, is more in-detergent stable than the parent lipolytic enzyme.

3. A detergent composition according to claim 1, wherein the variant of a parent lipolytic enzyme has alterations of the amino acids at the positions 231+233 and one of:
(a) 27;
(b) 216; or
(c) 256;
and wherein optionally, said variant furthermore comprises 227; which positions are corresponding to SEQ ID NO: 2.

4. The detergent composition according to claim 1, wherein the variant has the substitution of an amino acid residue at one of 27R, 216P, 227G, 231R, 233R or 256K of SEQ ID NO: 2.

5. The detergent composition according to claim 1, wherein the variant has the substitution of an amino acid residue at one of D27R, S216P, L227G, T231R, N233R or P256K of SEQ ID NO: 2.

6. The detergent composition according to claim 1, wherein the variant comprises substitutions selected from the group consisting of:
T231R+N233R+P256K;
L227G+T231R+N233R;
L227G+T231R+N233R+P256K;
D27R+T231R+N233R;
D27R+L227G+T231R+N233R; and
S216P+T231R+N233R.

7. The detergent composition of claim 1, wherein the parent lipolytic enzyme is at least 50%, or at least 60%, or at least 70%, or at least 75%, or at least 80%, or at least 85%, or at least 90%, or at least 95%, or at least 96%, or at least 97%, or at least 98%, or at least 99%, or even 100% identical to SEQ ID NO: 2.

8. The detergent composition according to claim 1, wherein the parent lipolytic enzyme is a lipase produced by Thermomyces lanuginosus DSM 4109 and having the amino acid sequence of SEQ ID. NO: 2.

9. The detergent composition of claim 1, wherein the composition is in the form of a liquid.

10. A composition according to claim 1, wherein the composition comprises:
(a) from 0 wt % to 10 wt % zeolite builder;
(b) from 0 wt % to 10 wt % phosphate builder; and
(c) optionally, from 0 wt % to 5 wt % silicate salt; and
wherein the composition optionally has a reserve alkalinity of greater than 7.5.

11. A composition according to claim 1, wherein the composition comprises a photobleach selected from xanthene dye photobleach, a photo-initiator and mixtures thereof.

12. A composition according to claim 1, wherein the composition comprises a fabric hueing agent.

13. A composition according to claim 12, wherein the fabric hueing agent is selected from Direct Violet 9, Direct Violet 99, Acid Red 52, Acid Blue 80 and mixtures thereof.

14. A composition according to claim 1, wherein the composition comprises a bleach catalyst.

15. A composition according to claim 1, wherein the composition comprises an enzyme selected from glycosyl hydrolase, protease, amylase, oxidase and mixtures thereof.

16. A composition according to claim 1, wherein the composition comprises a compound selected from:
(a) amphiphilic alkoxylated grease cleaning polymer;
(b) a random graft copolymer comprising:
(i) hydrophilic backbone comprising monomers selected from the group consisting of: unsaturated C₁-C₆ acids, ethers, alcohols, aldehydes, ketones, esters, sugar units, alkoxy units, maleic anhydride, saturated polyalcohols such as glycerol, and mixtures thereof; and
(ii) hydrophobic side chain(s) selected from the group consisting of: C₄-C₂₅ alkyl group, polypropylene, polybutylene, vinyl ester of a saturated C₁-C₆ mono-carboxylic acid, C₁-C₆ alkyl ester of acrylic or methacrylic acid, and mixtures thereof;
(c) a compound having the following general structure: bis((C₂H₅O)(C₂H₄O)n)(CH₃)—N⁺—CₓH₂ₓ—N⁺—(CH₃)-bis((C₂H₅O)(C₂H₄O)n), wherein n=from 20 to 30, and x=from 3 to 8, or sulphated or sulphonated variants thereof; and
(d) any mixture thereof.

17. A composition according to claim 1, wherein the composition comprises a perfume microcapsule.

18. A composition according to claim 1, wherein the composition comprises an encapsulated perfume and an unencapsulated perfume, wherein the weight ratio of perfume raw materials having the general structure: R¹R²R³CC(O)OR⁴, wherein R¹ R² R³ are each independently selected from H, alkyl, aryl, alkylaryl, cyclic alkyl, and wherein either at least one of R¹ R² R³ are H, present in the encapsulated perfume to those perfume raw materials also having the above general structure present in the unencapsulated perfume is greater than 3:1.

19. A composition according to claim 18, wherein the encapsulated perfume is encapsulated by melamine-formaldehyde and/or urea-formaldehyde.

20. A composition according to claim 1, wherein the composition comprises a perfume, wherein the perfume comprising at least 10 wt % of one or more perfume raw materials having a molecular weight of greater than 0 but less than or equal to 350 daltons, at least 80 wt % of said one or more perfume raw materials having a cLogP of at least 2.4, said perfume composition comprising at least 5 wt % of said one or more perfume components having a cLogP of at least 2.4.

21. A method of treating and/or cleaning a surface or fabric comprising the steps of optionally washing and/or rinsing said surface or fabric, contacting said surface or fabric with a composition according to claim 1, then optionally washing and/or rinsing said surface or fabric.

22. Use of the composition of claim 1 in the hydrolysis of a carboxylic acid ester.

23. Use of the composition of claim 1 in the hydrolysis, synthesis or interesterification of an ester.

24. Use of the lipolytic enzyme variant of claim 1 for the manufacture of an in-detergent stable formulation.


SEQUENCE LISTING (16 sequences)

SEQ ID NO: 1 - DNA, 873 bp, Thermomyces lanuginosus
  CDS (1)..(873)
  sig_peptide (1)..(51)
  propep (52)..(66)
  mat_peptide (67)..()
atgaggagctcccttgtgctgttctttgtctctgcgtggacggccttggccagtcctattcgtcgagaggtctcgcaggatctgtttaaccagttcaatctctttgcacagtattctgcagccgcatactgcggaaaaaacaatgatgccccagctggtacaaacattacgtgcacgggaaatgcctgccccgaggtagagaaggcggatgcaacgtttctctactcgtttgaagactctggagtgggcgatgtcaccggcttccttgctctcgacaacacgaacaaattgatcgtcctctctttccgtggctctcgttccatagagaactggatcgggaatcttaacttcgacttgaaagaaataaatgacatttgctccggctgcaggggacatgacggcttcacttcgtcctggaggtctgtagccgatacgttaaggcagaaggtggaggatgctgtgagggagcatcccgactatcgcgtggtgtttaccggacatagcttgggtggtgcattggcaactgttgccggagcagacctgcgtggaaatgggtatgatatcgacgtgttttcatatggcgccccccgagtcggaaacagggcttttgcagaattcctgaccgtacagaccggcggaacactctaccgcattacccacaccaatgatattgtccctagactcccgccgcgcgaattcggttacagccattctagcccagagtactggatcaaatctggaacccttgtccccgtcacccgaaacgatatcgtgaagatagaaggcatcgatgccaccggcggcaataaccagcctaacattccggatatccctgcgcacctatggtacttcgggttaattgggacatgtctt

SEQ ID NO: 2 - protein, 291 aa, Thermomyces lanuginosus
MRSSLVLFFVSAWTALASPIRREVSQDLFNQFNLFAQYSAAAYCGKNNDAPAGTNITCTGNACPEVEKADATFLYSFEDSGVGDVTGFLALDNTNKLIVLSFRGSRSIENWIGNLNFDLKEINDICSGCRGHDGFTSSWRSVADTLRQKVEDAVREHPDYRVVFTGHSLGGALATVAGADLRGNGYDIDVFSYGAPRVGNRAFAEFLTVQTGGTLYRITHTNDIVPRLPPREFGYSHSSPEYWIKSGTLVPVTRNDIVKIEGIDATGGNNQPNIPDIPAHLWYFGLIGTCL

SEQ ID NO: 3 - protein, 265 aa, Absidia reflexa
SSSSTQDYRIASEAEIKAHTFYTALSANAYCRTVIPGGRWSCPHCGVASNLQITKTFSTLITDTNVLVAVGEKEKTIYVVFRGTSSIRNAIADIVFVPVNYPPVNGAKVHKGFLDSYNEVQDKLVAEVKAQLDRHPGYKIVVTGHSLGGATAVLSALDLYHHGHANIEIYTQGQPRIGTPAFANYVIGTKIPYQRLVHERDIVPHLPPGAFGFLHAGEEFWIMKDSSLRVCPNGIETDNCSNSIVPFTSVIDHLSYLDMNTGLCL

SEQ ID NO: 4 - protein, 264 aa, Absidia corymbifera
SSSTQDYRIASEAEIKAHTFYTALSANAYCRTVIPGGQWSCPHCDVAPNLNITKTFTTLITDTNVLVAVGENEKTIYVVFRGTSSIRNAIADIVFVPVNYPPVNGAKVHKGFLDSYNEVQDKLVAEVKAQLDRHPGYKIVVTGHSLGGATAVLSALDLYHHGHDNIEIYTQGQPRIGTPEFANYVIGTKIPYQRLVNERDIVPHLPPGAFGFLHAGEEFWIMKDSSLRVCPNGIETDNCSNSIVPFTSVIDHLSYLDMNTGLCL

SEQ ID NO: 5 - protein, 269 aa, Rhizomucor miehei
SIDGGIRAATSQEINELTYYTTLSANSYCRTVIPGATWDCIHCDATEDLKIIKTWSTLIYDTNAMVARGDSEKTIYIVFRGSSSIRNWIADLTFVPVSYPPVSGTKVHKGFLDSYGEVQNELVATVLDQFKQYPSYKVAVTGHSLGGATALLCALDLYQREEGLSSSNLFLYTQGQPRVGDPAFANYVVSTGIPYRRTVNERDIVPHLPPAAFGFLHAGEEYWITDNSPETVQVCTSDLETSDCSNSIVPFTSVLDHLSYFGINTGLCT

SEQ ID NO: 6 - protein, 271 aa, Rhizopus oryzae
SASDGGKVVAATTAQIQEFTKYAGIAATAYCRSVVPGNKWDCVQCQKWVPDGKIITTFTSLLSDTNGYVLRSDKQKTIYLVFRGTNSFRSAITDIVFNFSDYKPVKGAKVHAGFLSSYEQVVNDYFPVVQEQLTAHPTYKVIVTGHSLGGAQALLAGMDLYQREPRLSPKNLSIFTVGGPRVGNPTFAYYVESTGIPFQRTVHKRDIVPHVPPQSFGFLHPGVESWIKSGTSNVQICTSEIETKDCSNSIVPFTSILDHLSYFDINEGSCL

SEQ ID NO: 7 - protein, 267 aa, Aspergillus niger
TAGHALAASTQGISEDLYSRLVEMATISQAAYADLCNIPSTIIKGEKIYNSQTDINGWILRDDSSKEIITVFRGTGSDTNLQLDTNYTLTPFDTLPQCNGCEVHGGYYIGWVSVQDQVESLVKQQVSQYPDYALTVTGHSLGASLAALTAAQLSATYDNIRLYTFGEPRSGNQAFASYMNDAFQASSPDTTQYFRVTHANDGIPNLPPVEQGYAHGGVEYWSVDPYSAQNTFVCTGDEVQCCEAQGGQGVNNAHTTYFGMTSGACTW

SEQ ID NO: 8 - protein, 266 aa, Aspergillus tubingensis
TAGHALAASTQGISEDLYSRLVEMATISQAAYADLCNIPSTIIKGEKIYNSQTDINGWILRDDSSKEIITVFRGTGSDTNLQLDTNYTLTPFDTLPQCNSCEVHGGYYIGWISVQDQVESLVQQQVSQFPDYALTVTGHSLGASLAALTAAQLSATYDNIRLYTFGEPRSNQAFASYMNDAFQASSPDTTQYFRVTHANDGIPNLPPADEGYAHGVVEYWSVDPYSAQNTFVCTGDEVQCCEAQGGQGVNNAHTTYFGMTSGHCTW

SEQ ID NO: 9 - protein, 276 aa, Fusarium oxysporum
AVGVTTTDFSNFKFYIQHGAAAYCNSEAAAGSKITCSNNGCPTVQGNGATIVTSFVGSKTGIGGYVATDSARKEIVVSFRGSINIRNWLTNLDFGQEDCSLVSGCGVHSGFQRAWNEISSQATAAVASARKANPSFNVISTGHSLGGAVAVLAAANLRVGGTPVDIYTYGSPRVGNAQLSAFVSNQAGGEYRVTHADDPVPRLPPLIFGYRHTTPEFWLSGGGGDKVDYTISDVKVCEGAANLGCNGGTLGLDIAAHLHYFQATDACNAGGFSWRR

SEQ ID NO: 10 - protein, 273 aa, Fusarium heterosporum
TVTTQDLSNFRFYLQHADAAYCNFNTAVGKPVHCSAGNCPDIEKDAAIVVGSVVGTKTGIGAYVATDNARKEIVVSVRGSINVRNWITNFNFGQKTCDLVAGCGVHTGFLDAWEEVAANVKAAVSAAKTANPTFKFVVTGHSLGGAVATIAAAYLRKDGFPFDLYTYGSPRVGNDFFANFVTQQTGAEYRVTHGDDPVPRLPPIVFGYRHTSPEYWLNGGPLDKDYTVTEIKVCEGIANVMCNGGTIGLDILAHITYFQSMATCAPIAIPWKR

SEQ ID NO: 11 - protein, 278 aa, Aspergillus oryzae
DIPTTQLEDFKFWVQYAAATYCPNNYVAKDGEKLNCSVGNCPDVEAAGSTVKLSFSDDTITDTAGFVAVDNTNKAIVVAFRGSYSIRNWVTDATFPQTDPGLCDGCKAELGFWTAWKVVRDRIIKTLDELKPEHSDYKIVVVGHSLGAAIASLAAADLRTKNYDAILYAYAAPRVANKPLAEFITNQGNNYRFTHNDDPVPKLPLLTMGYVHISPEYYITAPDNTTVTDNQVTVLDGYVNFKGNTGTSGGLPDLLAFHSHVWYFIHADACKGPGLPLR

SEQ ID NO: 12 - protein, 278 aa, Penicillium camemberti
DVSTSELDQFEFWVQYAAASYYEADYTAQVGDKLSCSKGNCPEVEATGATVSYDFSDSTITDTAGYIAVDHTNSAVVLAFRGSYSVRNWVADATFVHTNPGLCDGCLAELGFWSSWKLVRDDIIKELKEVVAQNPNYELVVVGHSLGAAVATLAATDLRGKGYPSAKLYAYASPRVGNAALAKYITAQGNNFRFTHTNDPVPKLPLLSMGYVHVSPEYWITSPNNATVSTSDIKVIDGDVSFDGNTGTGLPLLTDFEAHIWYFVQVDAGKGPGLPFKR

SEQ ID NO: 13 - protein, 270 aa, Aspergillus foetidus
SVSTSTLDELQLFAQWSAAAYCSNNIDSKDSNLTCTANACPSVEEASTTMLLEFDLTNDFGGTAGFLAADNTNKRLVVAFRGSSTIENWIANLDFILEDNDDLCTGCKVHTGFWKAWESAADELTSKIKSAMSTYSGYTLYFTGHSLGGALATLGATVLRNDGYSVELYTYGCPRIGNYALAEHITSQGSGANFRVTHLNDIVPRVPPMDFGFSQPSPEYWITSGNGASVTASDIEVIEGINSTAGNAGEATVSVLAHLWYFFAISECLL

SEQ ID NO: 14 - protein, 270 aa, Aspergillus niger
SVSTSTLDELQLFSQWSAAAYCSNNIDSDDSNVTCTADACPSVEEASTKMLLEFDLTNNFGGTAGFLAADNTNKRLVVAFRGSSTIKNWIADLDFILQDNDDLCTGCKVHTGFWKAWEAAADNLTSKIKSAMSTYSGYTLYFTGHSLGGALATLGATVLRNDGYSVELYTYGCPRVGNYALAEHITSQGSGANFPVTHLNDIVPRVPPMDFGFSQPSPEYWITSGTGASVTASDIELIEGINSTAGNAGEATVDVLAHLWYFFAISECLL

SEQ ID NO: 15 - protein, 269 aa, Aspergillus oryzae
DVSSSLLNNLDLFAQYSAAAYCDENLNSTGTKLTCSVGNCPLVEAASTQSLDEFNESSSYGNPAGYLAADETNKLLVLSFRGSADLANWVANLNFGLEDASDLCSGCEVHSGFWKAWSEIADTITSKVESALSDHSDYSLVLTGHSYGAALAALAATALRNSGHSVELYNYGQPRLGNEALATYITDQNKGGNYRVTHTNDIVPKLPPTLLGYHHFSPEYYISSADEATVTTTDVTEVTGIDATGGNDGTDGTSIDAHRWYFIYISECS

SEQ ID NO: 16 - protein, 251 aa, Landerina penisapora
PQDAYTASHADLVKYATYAGLAYQTTDAWPASRTVPKDTTLISSFDHTLKGSSGYIAFNEPCKEIIVAYRGTDSLIDWLTNLNFDKTAWPANISNSLVHEGFLNAYLVSMQQVQEAVDSLLAKCPDATISFTGHSLGGALACISMVDTAQRHRGIKMQMFTYGQPRTGNQAFAEYVENLGHPVFRVVYRHDIVPRMPPMDLGFQHHGQEVWYEGDENIKFCKGEGENLTCELGVPFSELNAKDHSEYPGMH